(19) United States
(12) Patent Application Publication
(10) Pub. No.: US 2026/0009816 A1
(43) Pub. Date: Jan. 8, 2026

(54) SYSTEM AND METHOD FOR FLUID FLOW ASSESSMENT

(71) Applicants: The Penn State Research Foundation, University Park, PA (US); Regents of the University of Minnesota, Minneapolis, MN (US)

(72) Inventors: Samuel Jacobi Grauer, University Park, PA (US); Ke Zhou, University Park, PA (US); Joseph Patrick Molnar, University Park, PA (US); Jiarong Hong, University Park, PA (US)

(21) Appl. No.: 19/130,223

(22) PCT Filed: Nov. 20, 2023
(86) PCT No.: PCT/US2023/080547

§ 371 Date: May 15, 2025

Related U.S. Application Data
(60) Provisional application No. 63/426,893, filed on Nov. 21, 2022.

(51) Int. Cl. G01P 5/00; G01P 5/26

(52) U.S. Cl. CPC G01P 5/001; G01P 5/26

(57) ABSTRACT

A system for fluid flow assessment that includes a computer device having a processor connected to a non-transitory computer readable medium configured to receive image data from at least one camera device positioned to capture images of a flow of fluid passing through a region of interest. The computer device configured can be to perform a fluid flow assessment process by running code stored in the non-transitory computer readable medium defining the fluid flow assessment process to assess the fluid flow and/or particles within the fluid. Embodiments of a process for fluid flow and/or particle assessment can utilize camera image data as well for performing the assessment. A computer device can be configured to facilitate the assessment of such data.

### CROSS-REFERENCE TO RELATED APPLICATIONS

The present application claims priority to U.S. Provisional Patent Application No. 63/426,893, filed on Nov. 21, 2022. The entirety of this provisional patent application is incorporated by reference herein.

### FIELD

The present innovation relates to systems, devices, and methods for three-dimensional (3D) fluid flow assessment (e.g. measurement, estimation, tracking and/or monitoring of fluid velocity fields and/or pressure fields, etc.). The assessed fluid flow can be a flow of liquid, gas, or other fluid. In some embodiments, the assessed fluid can also evaluate particulates within the fluid (e.g. particulates suspended within the fluid).

### BACKGROUND

Particle tracking velocimetry (PTV) is a method for estimating three-dimensional (3D) three-component (3C) velocity fields. This process typically tracks velocity fields over time by use of solid particles, or bubbles, or droplets as “tracers” that are recorded using camera imaging, synthetic aperture (SA) imaging, plenoptic imaging, or digital inline holography (DIH). Individual particles are localized in each frame via epipolar geometry or numerical refocusing, depending on the nature of a measurement, and the particles are tracked in time using an algorithm. Time-resolved particle positions are employed to determine the velocity field with one of a number of PTV algorithms, and localization and tracking are often performed such that a pressure field can be inferred from post-processing of the velocity data obtained from one of these measurements. Although the particles are intended to precisely follow the surrounding flow under this approach, the particles oftentimes lag the carrier fluid or travel ballistically, resulting in a “slip velocity”.

Regardless of the imaging modality, PTV workflows often involve at least two steps: (1) particle localization and tracking and (2) reconstruction of the velocity and pressure fields. Measurement data may also need to be interpreted in the context of uncertainty concerning the measured data. In such situations, a third step, referred to as uncertainty quantification (UQ), is also utilized to try and understand the limitations of the measurements.

### (1) Localization and Tracking

Particle localization is an inverse problem. The forward problem corresponding to particle localization involves forming an image of one or more particles in known positions using a measurement model that mimics the image formation process. In particle localization, this forward model can be inverted to locate particles from the real image data. Distinct imaging modalities generally require a tailored localization algorithm for this process. Conventional scattering diagnostics are often implemented with two or more cameras and epipolar geometry is utilized to relate the multiple synchronous images of a particle to its 3D location. For plenoptic or SA imaging and DIH, numerical refocusing is often used to localize particles in a flow. Regardless of the modality, a tracking algorithm is employed to identify specific localized particles and follow them across a sequence of imaging frames.

Epipolar type particle localization is a multi-camera technique that is premised on the basic idea that a particle's location in a single image corresponds to a line-of-sight through physical space so that the lines-of-sight for one particle from two or more images can be employed to triangulate that particle's 3D position. Given camera location information and sensor parameters, camera transforms can be manipulated to directly estimate the position of a particle. However, this approach is an idealization that often leads to significant errors in the context of precision velocimetry. Consequently, the camera transforms are conventionally augmented with a polynomial distortion model to account for the radial, tangential, and other distortions that are characteristic of the cameras' lens and lens mount (e.g. Scheimpflug adaptor). Alternatively, the camera transforms may be replaced by a fully empirical “Soloff” style model. These augmented camera models entail a nonlinear relationship between the camera locations and other parameters (often in the form of high-order polynomial functions) so nonlinear optimization can be employed to find the most probable 3D location of a particle that corresponds to two or more 2D locations of that particle in simultaneous images of the particle.

Triangulating a particle in this manner generally requires knowledge of a specific particle's position in multiple images and a calibration function for each camera that relates the image locations to the corresponding line-of-sight for the camera. Under many conditions, a centroid of a particle in a single image can be determined to sub-pixel accuracy by a Gaussian peak fitting procedure. Finding the same particle in another image, however, is more involved because particle images typically contain thousands of particles that are visually indistinguishable. Particle matching is therefore often implemented via a probabilistic, sequential procedure in which a particle is selected in one image and its centroid location is estimated. Thereafter, epipolar lines for the corresponding line-of-sight are traced in the other images. Particles that lie close to these lines are identified as a candidate match. Each candidate particle can yield an epipolar line in the other images that can be leveraged to narrow down this selection. Once the suitable candidates are chosen in all the images, the 3D position that minimizes the distance to the line-of-sight from each camera is imputed to that particle. This approach is typically used so that simultaneous images from several cameras can be employed to localize particles for PTV in conventional processing.

Numerical refocusing is a depth sensing technique that can be performed with a single vantage point (as compared to use of triangulation via a multi-camera approach). Particles are located in a 2D image (e.g. images obtained with a plenoptic, SA, or holographic technique). These measurements can record information about a particle's depth and, once that is known, the image data is refocused at the source plane. In this plane, the refocused diameter is presumed to correspond to the true diameter of the particle. However, since the particle depth is unknown, each particle is refocused to a series of planes that are oriented normal to the imaging plane and span the measurement domain. The diameter of the refocused particle in these successive planes is used to estimate its true 3D location by selecting the plane in which the refocused diameter is at a minimum. The accuracy of this depth sensing approach is relatively poor and results in an anisotropic distribution of uncertainty which is elongated along the imaging axis. Various algorithms have been developed to try and improve this procedure, which can greatly complicate this procedure and the refocusing operation without necessarily providing a substantial improvement in accuracy or precision.

Refocusing and localization techniques discussed above are designed to identify the 3D position of multiple particles in a fluid based on 2D image data. Once localization has been performed, the particles are tagged or tracked to determining their displacement between image frames (e.g. displacement over time). Tracking algorithms seek to match specific particles in sequential frames for a tracked set of particles. This is often done by minimizing a cost function that is designed to be low for tracks that truly follow a single particle and high for tracks that are incomplete or contain an erroneous match. Often, these approaches perform poorly for high particle seeding densities since the minimum displacement assumption becomes less accurate with more particles.

### (2) Velocity and Pressure Reconstruction

Lagrangian particle position data is typically converted to Lagrangian velocity data and then projected onto a regular Eulerian grid to facilitate conventional velocity and pressure reconstruction based on the localization and tagging data that can be obtained (e.g. via the above discussed approaches). This information can be utilized to refine a velocity field with a physics-based post-processing tool, estimate a pressure field, and extract coherent flow structures by plotting isosurfaces of the Q-criterion, for example, which can be used to visualize vortical flow structures.

Pressure information is often of interest for studying aerocoustics or surface loading phenomena and there are numerous algorithms that have been developed to recover velocity and pressure fields for this purpose.

For example, velocity fields determined by interpolating the Lagrangian PTV velocity data onto an Eulerian grid may be post-processed to compute a pressure field. Such approaches often utilize one of two options: (a) direct integration of the pressure gradients determined from the simplified Navier-Stokes equations, Euler equations, or other governing equations along a path or (b) solving the global pressure Poisson equation. Alternatively, the velocity and pressure fields may be obtained synergistically by attempting to solve the governing equations with velocity fields that also match the PTV data, as is done by the FlowFit and Vortex-in-Cell #solvers.

### (3) UO

Quantifying uncertainty in PTV fluid flow evaluations is often performed by simulating a PTV experiment and varying key elements of the workflow to isolate and assess their effect on the parameters inferred from the measurement data or calculations. Such a simulation, however, fails to reproduce all the salient sources of error that may be present. Ongoing research on UQ for PTV is focused on the development of Bayesian techniques that can give a comprehensive account of combined experimental and algorithmic uncertainty.

### SUMMARY

We have determined that there is significant uncertainty in the tracked particle positions using conventional PTV processes. The uncertainty of tracked positions represents a substantial error in velocity and pressure field estimates. For example, we determined that a lack of knowledge and/or accounting of the particle properties can prevent the accurate reconstruction of the velocity, pressure, density, and other fields in flows wherein the particles are subject to inertial transport. Uncertainty about the tracked positions, particle properties, or both may lead to substantial errors in the velocity, pressure, and other fields estimated by a PTV reconstruction algorithm.

This is particularly true for single-camera techniques that are used in applications where optical access is limited, such as plenoptic imaging and DIH, which can be subject to larger measurement errors. Particle localization uncertainties arise due to experimental and numerical factors, which can include camera noise, laser intensity and pulse separation variance, calibration errors, and numerical evaluation errors that can occur (e.g. inaccurate particle segmentation and identification as well as discretization errors). These uncertainties are unavoidable and lead to Lagrangian velocity estimates that can be very inaccurate and thereby cause the Eulerian velocity field estimates to be inaccurate. Such inaccuracies are very difficult to correct in post-processing due to the complicated nature of PTV algorithms, which compounds these issues.

Furthermore, in numerous high-speed, reactive, and multiphase flows, there are hydrodynamic and body forces acting on the particles that can prevent the particles from faithfully following the flow of the carrier fluid, which limits the accuracy and applicability of PTV in these contexts. These inertial particle transport effects (also referred to as so-called non-ideal advection effects) can include Stokes drag, which occurs at high flow velocities, thermophoresis, which occurs in the presence of large temperature gradients (e.g. in a combustion process), and other forces, e.g. gravity or magnetic forcing. Non-ideal tracer behavior leads to an apparent velocity field, obtained by a PTV algorithm, that does not match the velocity of the carrier fluid, which is typically the quantity of interest. Equations of motion for the particles can be included in the reconstruction algorithm to properly compensate for these effects in the PTV measurements.

Another limitation of all previously reported systems and processes for flow field reconstruction from PTV data that we are aware of is the assumption that the particles faithfully follow the flow, termed passive tracers. This behavior does not hold true in PTV measurement scenarios where the particles have too much inertia; are subject to strong gravitational, buoyancy, magnetic, or other body forces; or are collectively too numerous, leading to a large particle volume or mass loading, to act as passive “tracers”. These criteria are often breached in several common fluid measurement scenarios, including PTV of high-speed flows, in which the particles may pass through a shock wave or encounter other compressible phenomena within the carrier fluid, leading to both lagging and ballistic particle trajectories, as well as inherently multiphase flows like sprays, snowfall, bubbly flow, and sediment mixing, wherein the particles are also prone to inertial transport. For instance, in many flows that sustain inertial particle transport, the particle properties (e.g. size, density, and shape) are not known, a priori, and may differ from particle to particle. Therefore, it can be necessary to solve the flow reconstruction and particle characterization problems synchronously. We have found that failing to account for inertial particle transport, when it occurs in the measured flow, in the flow reconstruction algorithm is a source of significant errors in the Eulerian velocity, pressure, other field estimates produced by a PTV reconstruction algorithm.

We have developed embodiments of a new system and process that can address such issues and provide a stable, simple to implement system and process that also generates highly accurate velocity field assessments and can naturally compensate for measurement noise and inertial particle transport (e.g. non-ideal advection effects). Embodiments of our system and process can provide highly accurate 3D velocity field assessments even in the presence of significant measurement noise and tracking error environments. Moreover, embodiments of our system and process can be configured to provide accurate estimates of previously unmeasured fields and properties, such as the carrier fluid density and temperature and the characteristics of individual inertial particles (e.g. size, density, shape, etc.).

Some embodiments can be configured to reconstruct time-resolved 3D Eulerian flow fields in addition to the velocity and pressure fields from PTV data. Other embodiments can be configured to simultaneously estimate the velocity, pressure, density, and other flow fields from error-laden PTV data. Besides embodiments of the present innovation, we are unaware of any systems or processes that can reconstruct time-resolved 3D Eulerian flow fields in addition to the velocity and pressure fields from PTV data.

In some embodiments, a physics-informed neural network (PINN) can be provided to simultaneously estimate the velocity and pressure fields from error-laden particle positions or can be configured to simultaneously estimate the velocity, pressure, density, and other flow fields from error-laden PTV data. For example, the PINN can represent the carrier fluid fields in functional form at a low computational cost, and this function can be optimized in an unsupervised configuration using standard deep learning tools.

Training of the PINN can be based on an objective loss function that contains a “physics loss” to satisfy the equations governing fluid motion (e.g. Navier-Stokes equations, Euler equations, or other governing equations), a physics loss to satisfy the equations governing particle motion (e.g. Maxey-Riley equation and modifications thereof), and a “data loss” to compare synthetic measurements generated using the PINN to tracked particle positions. The data loss aspect can provide at least two improvements. First, an explicit particle advection model can be incorporated through numerical integration of the PINN or data-constrained polynomials, the latter of which may represent inertial particle trajectories (e.g. due to Stokes drag or thermophoresis). The ability to compensate for particle inertial expands the types of flows that can be reliably measured. This advection approach can be referred to as particle advection velocimetry (PAV).

Second, the data loss aspect can be formulated using a statistical approach to compensation for arbitrary particle localization uncertainties. This latter, statistical approach can be referred to as stochastic PAV (SPAV). The PAV or SPAV that is utilized can be a flexible framework that can accommodate various PTV modalities and can greatly improve the accuracy of velocity, pressure, and other flow field estimates or the accuracy of the at a reasonable computational cost.

While the PINN embodiment of our system utilizes a neural network to evaluate the carrier fluid and particle physics losses (i.e. governing equations), other embodiments of our system can employ 4D adjoint-variational, ensemble variational, Kalman filter, state observer, and other data assimilation techniques to implement a physics-based constraint subject to a PAV or SPAV data loss. Regardless of the embodiment of our system, the use of a PAV or SPAV data loss can significantly improve the accuracy of PTV by explicitly modeling the physics of particle advection and accounting for localization and tracking uncertainties.

Embodiments of our system can include at least one computer device (e.g. a controller, a workstation, a computer) that includes a processor connected to non-transitory memory and at least one transceiver unit. The processor can run an application stored in the memory that defines the PINN, for example. In some embodiments, the at least one computer device can be structured as a neural network. Other embodiments can utilize a different configuration for the computer device to run at least one fluid flow assessment process. The fluid flow assessment process can be defined to evaluate fluid flow, particle transport provided via the fluid flow, or both the fluid flow and the particle transport provided via the fluid flow. The fluid flow assessment process can be pre-defined as code that is stored in memory of the computer device that can be run by the processor of the computer device.

It should be appreciated that at least one input device, input/output device, and/or output device can also be communicatively connected to or included in the at least one computer device. For instance, a pointer device, a touch screen, a printer, and/or a keyboard can be communicatively connected to the processor. The transceiver unit can include one or more network transceivers (e.g. a cellular network transceiver, local area network transceiver, wireless network transceiver, etc.). The system can include at least one camera and at least one light source that are positionable in or adjacent a conduit, vessel, or unconfined region of interest so that the light source can illuminate a fluid passing in the vessel, conduit, or unconfined region of interest and the camera can capture images of the fluid within a pre-defined or pre-selected measurement domain (e.g. particular portion of a vessel or conduit, portion of a body of fluid in a pre-selected region or a pre-defined region, etc.). The camera and/or light source can also be communicatively connected to at least one computer device to provide image data and light emission related data (e.g. laser operational data) to the computer device(s).

In some implementations, the at least one computer device can be a cloud based server that hosts a service. The image data from the camera can be provided via at least one intermediate computer device (e.g. a user device that uses the service hosted by the at least one computer device via at least one network such as the internet or a wide area network). In other implementations, the computer device can be physically positioned to receive the camera data and other data via a local area network connection, a type of near field communication connection (e.g. Bluetooth connection), or a more hard-wired type of communicative connection (e.g. a wired communicative connection, etc.).

The fluid that is imaged can include particulates included therein (e.g. solid particulates suspended within a liquid fluid, gasoues particulates within a liquid fluid, atomized liquid particulates within a gaseous fluid, solid particulates suspended within a fluid that includes liquid and/or gas, etc.). The system can also include a particulate feeding device that provides a feed of particulates from a source of particulates for providing the particulates to the fluid and/or injecting the particulates within the fluid upstream of where the camera may capture images of the fluid within a vessel, conduit, or in an unconfined region of interest (e.g. outdoor airflow containing dust or snow, water flowing in a river, etc.).

The system can also include one or more sensors that can be communicatively connectable to the at least one computer device. The sensors can provide sensor data concerning the fluid. For example, the sensors can include temperature, pressure, and/or flow sensors that can provide temperature, pressure, and/or flow rate measurement data to the computer device(s) for use by the computer device(s). The sensors can be arranged upstream of a location at which the camera can image the fluid, downstream of that location, and/or at the location to provide such measurement data.

As discussed above, in some embodiments, the at least one computer device can be configured to utilize the image data from the camera and/or other data from the sensor(s) and/or at least one light emitting device in implementation of the PAV and/or SPAV techniques for assessment of the velocity and pressure fields of the fluid (e.g. estimation or measurement of the fields, etc.) and provide a display for the determined fields to visually represent the 3D velocity and/or pressure fields. The displayed output can be used to better understand the fluid flow for use in various situations (e.g. research being conducted to better understand details about a fluid flowing in a particular environment, facilitate design and development work, fix a design to address a fluid flow issue, etc.).

In other embodiments, the at least one computer device can be configured to utilize the image data from the camera and/or other data from the sensor(s) and/or at least one light emitting device in implementation of the PAV and/or SPAV techniques for assessment of the velocity, pressure, and other fields of the fluid (e.g. estimation or measurement of the fields, etc.), as well as inferred characteristics of any inertial particles suspended in the fluid (e.g. determination of the particles' size, density, shape, etc.), and provide a display for the determined fields to visually represent the 3D flow fields and particle states. The displayed output can be used to better understand the fluid flow for use in various situations (e.g. research being conducted to better understand details about a fluid flowing in a particular environment, facilitate design and development work, fix a design to address a fluid flow issue, etc.) or to determine otherwise unknown characteristics of the particles that may be of interest (e.g. to passively assess the performance of an engineering device that contains disperse multiphase flow).

A system for fluid flow assessment can be provided. In some embodiments, the system can include a computer device having a processor connected to a non-transitory computer readable medium configured to receive image data from at least one camera device positioned to capture images of a flow of fluid passing through a region of interest. The computer device can be configured to perform a fluid flow assessment process by running code stored in the non-transitory computer readable medium defining the fluid flow assessment process such that the computer device is configured to utilize at least one of:

$${ℒ}_{data}^{PAV} = \frac{1}{{n}_{p}} {\sum }_{i = 1}^{{n}_{p}} {‖ {\hat{x}}_{2}^{i} - {x}_{2} ( {\hat{x}}_{1}^{i} , θ ) ‖}_{2}^{2} and \qquad ( 1 )$$

$${L}_{data}^{SPAV} = - {\sum }_{1}^{{n}_{p}} log [ P ( {\hat{x}}_{2}^{i} \vert {\hat{x}}_{1}^{i} , θ ) ] , \qquad ( 2 )$$

wherein, utilization of Eq. (2) includes numerical approximations of at least one of:
a) SPAV-MC:

$$P ( {\hat{x}}_{2} \vert {\hat{x}}_{1} , θ ) \approx \frac{1}{{n}_{s}} {\sum }_{j = 1}^{{n}_{s}} P ( {\hat{x}}_{2} \vert {\hat{x}}_{1}^{j} , θ ) , \qquad ( 3 )$$

b) SPAV-MVN:

$$P ( {\hat{x}}_{2} \vert {\hat{x}}_{1} , θ ) = {det [ 2 π ( Γ + {\hat{Γ}}_{2} ) ]}^{- 1 / 2} exp [ - \frac{1}{2} {( {\hat{x}}_{2} - {\hat{μ}}_{2} )}^{\text{?}} {( Γ + {\hat{Γ}}_{2} )}^{- 1} ( {\hat{x}}_{2} - {\hat{μ}}_{2} ) ] , and \qquad ( 4 )$$

$$\text{?} \text{indicates text missing or illegible when filed}$$

c) SPAV-FE (based on SPAV-MVN):

$${\hat{μ}}_{2} = \frac{1}{6} ( {x}_{2}^{+ 1} , {x}_{2}^{- 1} , {x}_{2}^{+ 2} , {x}_{2}^{- 2} , {x}_{2}^{+ 3} , {x}_{2}^{- 3} ) , \qquad ( 5 )$$

$$U \sum {V}^{\text{?}} = [ {x}_{2}^{+ 1} , {x}_{2}^{- 1} , {x}_{2}^{+ 2} , {x}_{2}^{- 2} , {x}_{2}^{+ 3} , {x}_{2}^{- 3} ] - {\hat{μ}}_{2} {1}^{\text{?}} , and \qquad ( 6 )$$

$${\hat{Γ}}_{2} = \frac{1}{2} {U}^{\text{?}} {\sum }^{o 2} U \qquad ( 7 )$$

$$\text{?} \text{indicates text missing or illegible when filed}$$

For Eqs. (1) and (2), [symbol] _{data} is a measurement component of an objective loss designed for velocity and pressure reconstruction and the superscripts “PAV” and “SPAV” indicate particle advection velocimetry (PAV) and stochastic particle advection velocimetry (SPAV) and P is a probability density function (PDF). The summations can cover a total of nₚ localized particle pairs and the vector \hat{x}ⁱ=[x, y, z]^{T} denotes the position of the ith individual particle, where the symbol A indicates an estimated quantity, and the subscripts 1 and 2 denote the position before and after \hat{ } advection, respectively. The vector θ contains the current estimate of the velocity and pressure fields. For Eqs. (3) to (7), nₛ denotes the number of Monte Carlo samples, \hat{x}ⁱ, drawn from the localization PDF before advection, the matrix Γ is a covariance matrix that characterizes a generic particle measurement uncertainty, symbols \hat{μ}₂ and \hat{Γ}₂ denote an estimated mean position and covariance matrix of the particle advected from the position \tilde{x}₁, symbol \tilde{x}₂^{±j} denotes advected points in the fluid element (FE) approximation that are placed along the jth principal axis of a 3D localization file, the sign of the superscript represents either a positive or negative direction along a principal axis, U and V are singular matrices that are obtained by applying a singular value decomposition to a right hand side of Eq. (6), and Σ is a diagonal matrix that contains the corresponding singular values and is obtained in the same decomposition; 1 is a 6×1 vector of ones; and ^{o2} is a Hadamard exponent.

In other embodiments, the system for fluid flow assessment can include a computer device having a processor connected to a non-transitory computer readable medium configured to receive image data from at least one camera device positioned to capture images of a flow of fluid passing through a region of interest wherein the computer device is configured to perform a fluid flow assessment process by running code stored in the non-transitory computer readable medium defining the fluid flow assessment process such that the computer device is configured to utilize at least one of:

$${ℒ}_{d a t a}^{PAV} ( {Θ}_{x} ) = \frac{1}{{n}_{p}} {\sum }_{k - 1}^{{n}_{p}} \frac{1}{{n}_{k} - 1} {\sum }_{j = 1}^{{n}_{k} - 1} {‖ {θ}_{x , j}^{k} - {x}_{j}^{k} ‖}_{2}^{2} and \qquad ( 1 )$$

$${ℒ}_{data}^{SPAV} ( {Θ}_{x} ) = - {\sum }_{k = 1}^{{n}_{p}} {\sum }_{j = 1}^{{n}_{k} - 1} P ( {x}_{j}^{k} \vert {θ}_{x , j}^{k} ) , \qquad ( 2 )$$

wherein for Eqs. (1) and (2), [symbol] _{data} is a measurement component of an objective loss designed for velocity and pressure reconstruction and the superscripts “PAV” and “SPAV” indicate particle advection velocimetry (PAV) and stochastic particle advection velocimetry (SPAV). The summations can cover a total of nₚ localized particle pairs; the subscripts 1 and 2 denote positions before and after advection, respectively; vector θ contains a current estimate of the velocity and pressure fields;

$${θ}_{x , j}^{k}$$

is an advected location of a kth particle at a jth step, nₖ is a number of positions recorded along a track,

$${x}_{j}^{k}$$

is a particle position for a kth particle at a jth step, P is a probability density function, and Θ_{X} is a tensor.

In some embodiments, the system, the fluid flow assessment process is a particle advection velocimetry (PAV) process or a stochastic particle advection velocimetry (SPAV) process.

Embodiments of the system can also include other elements. For example, the system can include a structure. The structure can include a vessel or a conduit that contains the fluid flow to be measured (e.g. can be a flow tank or other type of vessel or conduit, etc.).

As another example, the system can include at least one sensor communicatively connected to the computer device. The at least one sensor can be positioned to provide measurement data about the flow of fluid.

The system can also include the camera and a light source positioned to illuminate a pre-selected region of the region of interest for image capturing by the camera. In some configurations, the light source can include a laser or at least one light emitting device.

The system can also have a fluid flow drive mechanism connected to a structure through which the flow of fluid passes through the region of interest.

As yet another example, the system can include a particulate feeding device positioned to provide a feed of particulates from a source of particulates for providing the particulates to the flow of fluid at a position that is upstream of a position of the camera.

In some embodiments, the fluid can be a gas, a liquid, can be a mixture of gas and liquid, or can include at least one gas and/or at least one liquid. The flow of fluid can also include particles. The particles can include solid particulates, droplets of a liquid, or cellular material in some embodiments.

The fluid flow assessment process can be configured to assess particle transport in some embodiments. In other embodiments, the the fluid flow assessment process can be configured to assess fluid flow and particle transport that occurs via the fluid flow. In yet other embodiments, the fluid flow assessment process can be configured to assess the flow of fluid.

A method for fluid flow assessment can also be provided. Some embodiments of the method can include capturing images of a flow of fluid having particles therein and analyzing image data of the captured images to perform a fluid flow assessment, the fluid flow assessment including performance of one or more of:

$${ℒ}_{data}^{PAV} = \frac{1}{{n}_{p}} {\sum }_{i = 1}^{{n}_{p}} {‖ {\hat{x}}_{2}^{i} - {x}_{2} ( {\hat{x}}_{1}^{i} , θ ) ‖}_{2}^{2} and \qquad ( 1 )$$

$${L}_{data}^{SPAV} = - {\sum }_{i = 1}^{{n}_{p}} log [ P ( {\hat{x}}_{2}^{i} \vert {\hat{x}}_{1}^{i} , θ ) ] , \qquad ( 2 )$$

wherein utilization of Eq. (2) includes at least one numerical approximation of:
a) SPAV-MC:

$$P ( {\hat{x}}_{2} \vert {\hat{x}}_{1} , θ ) \approx \frac{1}{{n}_{s}} {\sum }_{j = 1}^{{n}_{s}} P ( {\hat{x}}_{2} \vert {\hat{x}}_{1}^{j} , θ ) , \qquad ( 3 )$$

b) SPAV-MVN:

$$P ( {\hat{x}}_{2} \vert {\hat{x}}_{1} , θ ) = {det [ 2 π ( Γ + {\hat{Γ}}_{2} ) ]}^{- 1 / 2} exp [ - \frac{1}{2} {( {\hat{x}}_{2} - {\hat{μ}}_{2} )}^{T} {( Γ + {\hat{Γ}}_{2} )}^{- 1} ( {\hat{x}}_{2} - {\hat{μ}}_{2} ) ] , \qquad ( 4 )$$

c) SPAV-FE (based on SPAV-MVN):

$${\hat{μ}}_{2} = \frac{1}{6} ( {x}_{2}^{+ 1} + {x}_{2}^{- 1} + {x}_{2}^{+ 2} + {x}_{2}^{- 2} + {x}_{2}^{+ 3} + {x}_{2}^{- 3} ) , \qquad ( 5 )$$

$$U \sum \text{?} = [ {x}_{2}^{+ 1} , {x}_{2}^{- 1} , {x}_{2}^{+ 2} , {x}_{2}^{- 2} , {x}_{2}^{+ 3} , {x}_{2}^{- 3} ] - {\hat{μ}}_{2} \text{?} , and \qquad ( 6 )$$

$${\hat{Γ}}_{2} = \frac{1}{2} \text{?} {\sum }^{o 2} U \qquad ( 7 )$$

$$\text{?} \text{indicates text missing or illegible when filed}$$

In Eqs. (1) and (2), [symbol] _{data} is the measurement component of an objective loss designed for velocity and pressure reconstruction and the superscripts “PAV” and “SPAV” indicate particle advection velocimetry (PAV) and stochastic particle advection velocimetry (SPAV), respectively. P is a probability density function (PDF), and the summations cover a total of nₚ localized particle pairs; the vector \hat{x}ⁱ=[x, y, z]^{T} denotes the position of the ith individual particle, where the symbol \hat{ } indicates an estimated quantity, and the subscripts 1 and 2 denote the position before and after advection, respectively; and the vector θ contains the current estimate of the velocity and pressure fields. For Eqs. (3) to (7), nₛ denotes the number of Monte Carlo samples, \tilde{x}ⁱ, drawn from the localization PDF before advection, matrix Γ is a covariance matrix that characterizes the generic particle measurement uncertainty, symbols \hat{μ}₂ and \hat{Γ}₂ denote an estimated mean position and covariance matrix of the particle advected from the position \tilde{x}₁, symbol x₂^{±j} denotes the advected points in the fluid element (FE) approximation that are placed along the jth principal axis of the 3D localization file; the sign of the superscript represents either a positive or negative direction along a principal axis, U and V are two singular matrices that are obtained by applying a singular value decomposition to the right hand side of Eq. (6), and Σ is a diagonal matrix that contains the corresponding singular values and is obtained in the same decomposition, and 1 is a 6×1 vector of ones and ^{o2} is a Hadamard exponent.

Other embodiments of the method for fluid flow assessment can include capturing images of a flow of fluid, the flow of fluid having particles therein and analyzing image data of the captured images to perform a fluid flow assessment, the fluid flow assessment including performance of one or more of:

$${ℒ}_{data}^{PAV} ( {Θ}_{x} ) == \frac{1}{{n}_{p}} {\sum }_{k = 1}^{{n}_{p}} \frac{1}{{n}_{k} - 1} {\sum }_{j = 1}^{{n}_{k} - 1} {‖ {θ}_{x , j}^{k} - {x}_{j}^{k} ‖}_{2}^{2} and \qquad ( 1 )$$

$${ℒ}_{data}^{SPAV} ( {Θ}_{x} ) = - {\sum }_{k = 1}^{{n}_{p}} {\sum }_{j = 1}^{{n}_{k} - 1} P ( {x}_{j}^{k} \vert {θ}_{x , j}^{k} ) , \qquad ( 2 )$$

wherein for Eqs. (1) and (2), [symbol] _{data} is a measurement component of an objective loss designed for velocity and pressure reconstruction and the superscripts “PAV” and “SPAV” indicate particle advection velocimetry (PAV) and stochastic particle advection velocimetry (SPAV). The summations can cover a total of nₚ localized particle pairs; the subscripts 1 and 2 denote positions before and after advection, respectively; vector θ contains a current estimate of the velocity and pressure fields;

$${θ}_{x , j}^{k}$$

is an advected location of a kth particle at a jth step, nₖ is a number of positions recorded along a track,

$${x}_{j}^{k}$$

is a particle position for a kth particle at a jth step, P is a probability density function, and Θ_{X} is a tensor.

In some embodiments of the method, the 3D localization file is a Portable Document Format file, a text format file (.txt), a comma-separated values (.csv) file, or a data (.dat) file. Other embodiments can utilize another type of file for the 3D localization file as well.

As with embodiments of the system, the fluid can be any type of fluid. For instance, the fluid can be a gas, a liquid, a mixture of gas and liquid or can include a gas and/or a liquid.

The particles can be droplets of a liquid, solid particulates, or cellular material in some embodiments of the method.

It should be appreciated that embodiments of the system can perform an embodiment of the method. Embodiments of the method can also include use of elements of an embodiment of the system. For example, the method can include other steps such as passing a fluid through a structure for capturing images of the fluid via at least one camera positioned in or adjacent the structure. As another example, the method can include feeding particulates into the fluid and/or utilizing one or more sensors to acquire data about the fluid (e.g. temperature, flow rate, etc.).

A non-transitory readable medium is also provided. The non-transitory readable medium can have code stored thereon that defined a method that can be performed by a processor connected to the memory. The method that is defined by the code can be an embodiment of our method for fluid flow assessment.

Other details, objects, and advantages of our apparatus, system, device, non-transitory computer readable medium, and method will become apparent as the following description of certain exemplary embodiments thereof proceeds.

### BRIEF DESCRIPTION OF THE DRAWINGS

The invention and embodiments thereof will be described below in further detail in connection with the drawings. It should be appreciated that like reference numbers can identify similar components.

FIG. 1 is a block diagram of an exemplary embodiment of a system for fluid flow assessment.

FIG. 2 is a schematic view of an exemplary embodiment of the at least one computer device 3 of the system 1 shown in FIG. 1.

FIG. 3 is a series of graphics illustrating different particle advection approaches using the PAV and SPAV processing options discussed herein in comparison to a conventional approach.

FIG. 4 is a graph illustrating ground truth flow data from a conducted simulation experiment.

FIG. 5 is a graph illustrating conventional flow data output from a conducted simulation experiment.

FIG. 6 is a graph illustrating flow data output using an exemplary embodiment of the process that utilized a PAV approach.

FIG. 7 is a series of graphs illustrating a comparison of ground truth flow data, conventional flow data, and flow data output from use of exemplary embodiments of our process utilizing PAV, SPAV approaches that included SPAV Monte Carlo, SPAV MVN and SPAV FE approaches from a conducted simulation experiment.

FIG. 8 is a block diagram of an exemplary embodiment of a pre-defined fluid flow assessment model that includes a model of inertial particle transport incorporated therein that can be utilized by the computer device 3 of the exemplary embodiment of the system for fluid flow assessment.

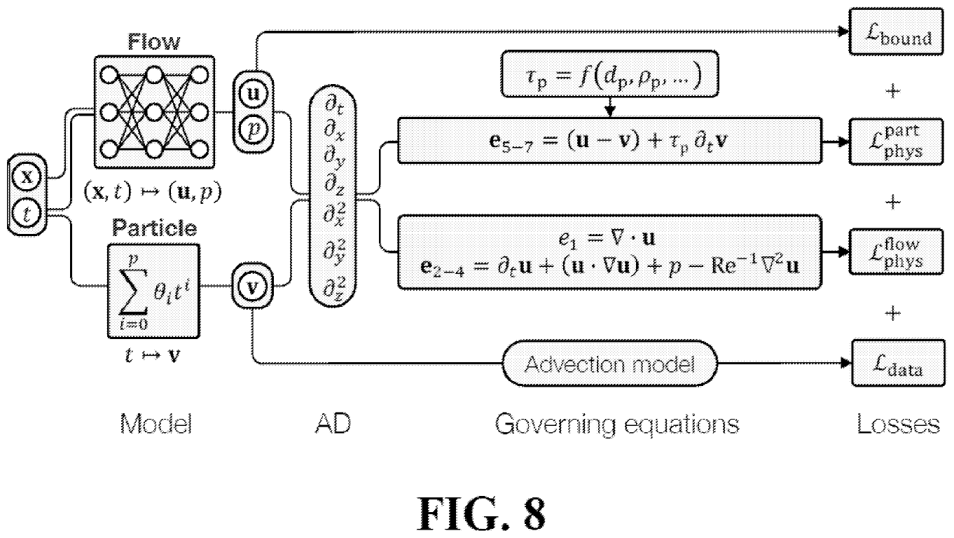

FIG. 9 is a set of graphs that depict ground truth vorticity fields and the fields that can be output from use of exemplary embodiments of our system.

### DETAILED DESCRIPTION

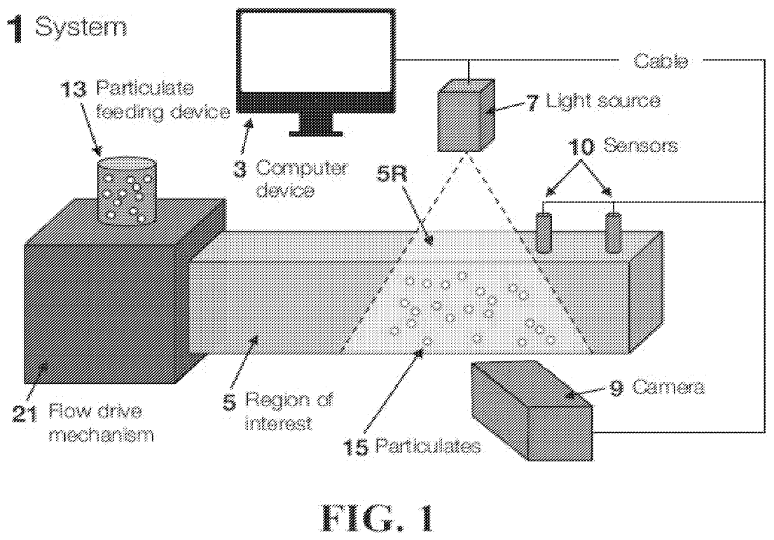

FIG. 1 illustrates an exemplary embodiment of a system 1 for fluid flow assessment. The system 1 can include at least one computer device 3 (e.g. a controller, a workstation, a computer, a computer configured as a neural network, a server configured as a neural network, a server, a group of servers, etc.) that includes a processor connected to non-transitory memory and at least one transceiver unit. The processor can run an application stored in the memory that defines the SPAV or PINN, for example. In some embodiments, the at least one computer device 3 can be structured as a neural network.

At least one input device, input/output device, and/or output device can be communicatively connected to or included in the at least one computer device 3. For instance, a pointer device (e.g. mouse, stylus, etc.), a touch screen, a printer, a monitor, buttons, and/or a keyboard can be communicatively connected to the processor. The transceiver unit can include one or more network transceivers (e.g. a cellular network transceiver, local area network transceiver, wireless network transceiver, etc.) and can also include other communicative transceivers (e.g. Bluetooth transceiver, one or more universal serial bus (USB) connector ports, etc.).

The system 1 can include at least one camera 9 and at least one light source 7 that are positionable in or adjacent a structure or region of interest 5 in which or through which a flow of fluid 4 can pass. The structure 5 can be a conduit (e.g. pipe, ductwork, tube, etc.) or a vessel (e.g. tank, turbine, combustion chamber, oven, etc.) so that the light source 7 can illuminate a fluid passing in the structure 5 and the camera 9 can capture images of the fluid within a pre-defined or pre-selected portion 5R of the structure 5. Examples of a light source can include a laser, an array of lasers, a light emitting diode (LED) an array of LEDs, or other type of light source. For example, the light source can include a laser or other light emitting device that is arranged to emit a light to a sheet or mirror for directing the light emitted by the light source into the flow of fluid 4 within a pre-selected region 5R or pre-defined region 5R of the structure 5. The camera 9 can be connected to the structure 5 and/or positioned within the structure 5 to capture images of the flow of fluid 4 within this region 5R. The emitted light can be sufficient to illuminate particulates within the fluid 4 for being captured by the images taken by the camera. The camera 9 and/or light source 7 can also be communicatively connected to the at least one computer device 3 to provide image data from the camera 9 and light emission related data from the light source 7 (e.g. laser operational data) to the computer device(s) 3.

The system 1 can also include one or more sensors 10 that can be communicatively connectable to the at least one computer device 3. The sensors 10 can provide sensor data concerning the fluid. For example, the sensors 10 can include temperature, pressure, and/or flow sensors that can provide temperature, pressure, and/or flow rate measurement data to the computer device(s) 3 for use by the computer device(s) 3. The sensors 10 can be arranged upstream of a location at which the camera 9 can image the fluid, downstream of that location, and/or at the location to provide such measurement data.

The flow of fluid 4 that is to be imaged via the camera 9 and light source 7 arrangement can include particulates included therein (e.g. solid particulates within a liquid fluid, atomized liquid particulates within a gaseous fluid, solid particulates within a fluid that includes liquid and/or gas, etc.). The system 1 can also include a particulate feeding device 13 that provides a feed of particulates 15 from a source of particulates for providing the particulates to the fluid and/or injecting the particulates within the fluid upstream of where the camera may capture images of the fluid within a vessel or conduit.

The system 1 can also include a fluid flow drive mechanism 21, which can be or include a pump, fan, compressor, or other type of fluid drive mechanism connected to the structure 5 to help drive the flow of fluid 4. The fluid flow drive mechanism 21 can be adjustably controlled to adjust the flow of the fluid 4 as well.

In other embodiments, the system 1 can be utilized in conjunction with an unconfined region of interest. Such a region of interest can be a portion of air, a lake, a river, a portion of the an ocean, or another unconfined space through which a fluid passes. In such embodiments, at least one structure 5 can be provided for mounting and/or positioning of the camera 5, light source 7, and/or sensors 10 (if utilized) in or adjacent the unconfined region of interest. In such embodiments, there may not be a fluid flow drive mechanism 21 that is utilized for driving the flow of fluid 4.

As discussed above and discussed further herein, the at least one computer device 3 can be configured to utilize the image data from the camera 9 and/or other data from the sensor(s) 10 and/or at least one light emitting device 7 in implementation of the PAV and/or SPAV techniques for assessment of the velocity and pressure fields of the fluid (e.g. estimation or measurement of the fields, etc.) and provide a display for the determined fields to visually represent the 3D velocity, pressure, density, and/or other fields. The displayed output can be used to better understand the fluid flow for use in various situations (e.g. research work being conducted to better understand details about a fluid flowing in a particular environment, facilitate design and development work, or working to fix a design to address a fluid flow issue, etc.).

In some implementations, the at least one computer device 3 can be a cloud based server that hosts a fluid flow assessment service. The image data from the camera 9 as well as sensor data from one or more sensors 10 (when utilized) can be provided via at least one intermediate computer device (e.g. a user device that uses the service hosted by the at least one computer device 3 via at least one network such as the internet or a wide area network) or via the camera 9 in the event the camera is communicatively connectable to the computer 3 via a network connection or other type of suitable communication connection. Data from the sensors 10 (when used) can also be provided via a network connection the sensors 10 may have to the computer device 3 in such an arrangement.

In other implementations, the computer device 3 can be physically positioned to receive the camera data from the camera 9 and other data via a local area network connection, a type of near field communication connection (e.g. Bluetooth connection), or a more hard-wired type of communicative connection (e.g. a wired communicative connection, etc.).

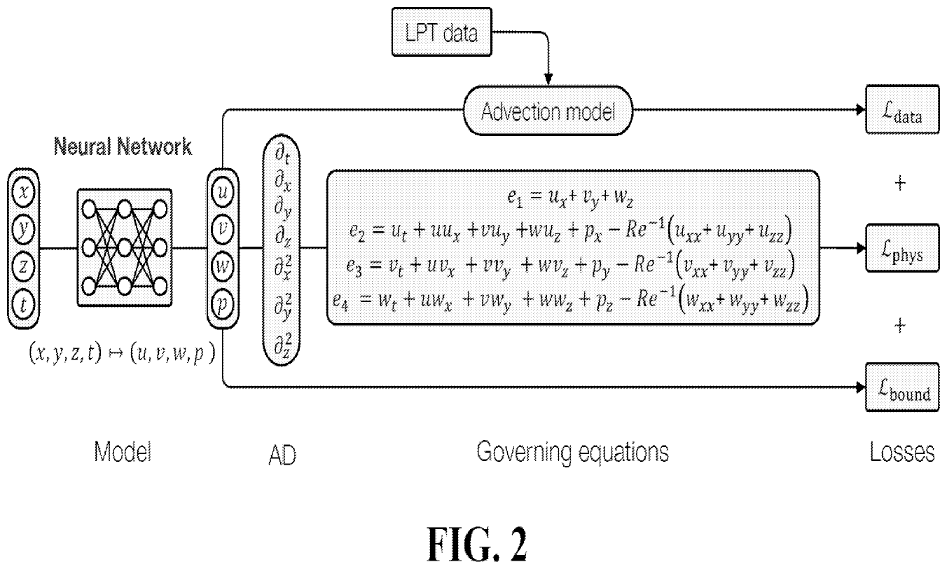

An exemplary at least one computer device 3 is schematically illustrated in FIG. 2. An exemplary embodiment of the at least one computer device can be configured as a neural network. The neural network can be a physics-informed neural network (PINN), for example. The PINN can be configured to utilize a pre-defined particle advection velocimetry (PAV) or stochastic particle advection velocimetry (SPAV) algorithm. In some embodiments, the PINN can be configured to simultaneously estimate velocity and pressure fields of the flow of fluid 4 from error-laden particle positions obtained via the camera 9. The PINN can function to provide a low-cost representation of flow fields in functional form that can be optimized in an unsupervised configuration using standard deep learning tools, for example.

Training of the PINN can be based on a loss function that contains a “physics loss” and a “data loss” to satisfy the governing equations (e.g. Navier-Stokes equations, Euler equations, etc.) and estimated particle positions. The data loss aspect can utilize an explicit particle advection model to capture particle trajectories that include non-ideal effects (e.g. Stokes drag or thermophoresis), which can expand the types of flows that can be reliably measured. This advection approach can be referred to as particle advection velocimetry (PAV). Second, the data loss aspect can be formulated using a statistical approach to compensation for arbitrary particle localization uncertainties. This statistical approach can be referred to as stochastic particle advection velocimetry (SPAV). The SPAV can be a type of PAV algorithm. The SPAV that is utilized can be defined to be a flexible framework that can accommodate various PTV modalities and can greatly improve the accuracy of velocity and pressure field estimates at a reasonable computational cost. The defined SPAV or PAV can be defined by code stored in a non-transitory memory of the at least one computer device 3 (or the computer devices of the PINN, for example) so that the SPAV or PAV is performed when a processor runs that stored code.

The PINN can be configured as a feed-forward neural network that can approximately solve for fluid velocity parameters based on a pre-defined set of differential governing equations. FIG. 2 illustrates an exemplary PINN configured for use of a PAV or SPAV set of algorithms. The PINN can be configured to provide a functional representation of the fluid flow of the flow of fluid 4 to map the spatio-temporal coordinates to velocity and pressure outputs, e.g. [symbol] :(x, y, z, t) [symbol] (u, v, w, p). Additional output fields can be added as well to account for other parameters of interest. As can be appreciated from FIG. 2, partial derivatives of the PINN can be computed using automatic differentiation and these quantities can be used to evaluate pre-defined governing equations. Residuals from this process can be added up into a “physics loss” that is to be minimized to obtain a physically plausible function. Also, the synthetic measurements can be computed using the outputted flow fields and a measurement model for comparison with real data (e.g. camera images obtained from the camera 9, particles localized from camera images obtained from the camera 9, etc.). Measurement residuals can be collected into a “data loss” as indicated in FIG. 2 as well. An aggregate loss (e.g., physics loss+data loss) can be minimized via a pre-defined backpropagation algorithm to produce a network that provides physical flow fields that reproduce the observed particle trajectories (e.g., particulate trajectories which were observed via the images taken by the camera 9, particles localized from camera images obtained from the camera 9, etc.).

For a simple PTV scenario, a suitable physics loss term can be defined in terms of the 3D incompressible Navier-Stokes equations that can be written in non-dimensional form and rearranged to obtain physics residuals as set forth in the exemplary equations below (and it should be appreciated that these terms can be adjusted to account for compressible and reactive flows of fluid as well):

$${e}_{1} = {u}_{x} + {v}_{y} + {w}_{z} , \qquad ( 3 )$$

$${e}_{2} = {u}_{t} + {uu}_{x} + {vu}_{y} + {wu}_{z} + {p}_{x} - {Re}^{- 1} ( {u}_{xx} + {u}_{yy} + {u}_{zz} ) ,$$

$${e}_{3} = {v}_{t} + {uv}_{x} + {vv}_{y} + {wv}_{z} + {p}_{y} - {Re}^{- 1} ( {v}_{xx} + {v}_{yy} + {v}_{zz} ) , and$$

$${e}_{4} = {w}_{t} + {uw}_{x} + {vw}_{y} + {ww}_{z} + {p}_{z} - {Re}^{- 1} ( {w}_{xx} + {w}_{yy} + {w}_{zz} ) ,$$

where (⋅)ₓ, (⋅)_{y}, (⋅)_{z}, and (⋅)ₜ are partial derivatives of the PINN and Re is the Reynolds number. A physics loss is constructed by integrating Eq. (3) over the measurement domain,

$${ℒ}_{phys} = \frac{1}{\vert 𝒱 \times 𝒯 \vert} {\int }_{𝒯} \int \int {\int }_{𝒱} {‖ [ {e}_{1} , {e}_{2} , {e}_{3} , {e}_{4} ] ‖}_{2}^{2} d 𝒱 dt . \qquad ( 4 )$$

In this expression, [symbol] and [symbol] are the spatial and temporal domains of interest, ∥⋅∥₂ is the Euclidean norm, and the residuals e₁-e₄ are a function of x, y, z, and t as well as the network's weights and biases, represented by the vector θ. Equation (4) set forth above can be implemented or approximated by Monte Carlo sampling. Alternative physics loss equations can be defined in a similar manner using the Euler equations or other governing equations, where appropriate.

The velocity of a particle can be calculated from its displacement between two temporally adjacent frames of images obtained from the camera 9 by the following Equation (5):

$${\hat{u}}_{1.5} \approx \frac{{\hat{x}}_{2} - {\hat{x}}_{1}}{Δ t} , \qquad ( 5 )$$

where x=[x, y, z]^{T} and u=[u, v, w]^{T} are position and velocity vectors, \hat{ } indicates a measured or estimated quantity, and Δt is the measurement interval (i.e. the time between the immediately adjacent frames received from the camera 9). Subscripts in Eq. (3) indicate the timestep and the velocity is imputed to the particle at the position \hat{x}_{1.5}=(\hat{x}₁+\hat{x}₂)/2. The simplest velocimetry data loss term can compare velocity estimates from Eq. (5) above to the PINN's output as follows:

$${ℒ}_{data}^{vel} = \frac{1}{{n}_{p}} {\sum }_{i = 1}^{{n}_{p}} {‖ {\hat{u}}_{1.5}^{i} - u ( {\hat{x}}_{1.5}^{i} , θ ) ‖}_{2}^{2} , \qquad ( 6 )$$

where nₚ is the number of particle pairs and

$$u ( {\hat{x}}_{1.5}^{i} , θ )$$

is the velocity field output from a PINN at position \hat{x}_{1.5} with parameters θ. The superscript “vel” on the left side of Eq. (6) indicates the conventional data loss, which may be replaced by our PAV and SPAV losses in the below noted Eq. (9) or (12), respectively. Network parameters are tuned by minimizing an overall objective loss function,

$${ℒ}_{total} = {ℒ}_{data} + {χℒ}_{phys} , \qquad ( 7 )$$

where χ is a regularization parameter that can be carefully selected.

While an exemplary computer device 3 is shown in FIG. 2 as being a PINN, the computer device 3 need not be configured as a PINN. The PAV and/or SPAV algorithms can be conducted different via a different type of computer device configuration using any differentiable, parametric representation of the flow fields. In particular, the PAV and/or SPAV algorithms can be embedded in a 4D adjoint-variational, ensemble variational, Kalman filter, and state observer data assimilation framework, among other data assimilation methods for fluid flow reconstruction. However, at this time we prefer use of a PINN because we believe it is a convenient tool for velocimetry because PINNs can provide a parsimonious representation of the flow and can be implemented at a relatively low computation cost.

The PAV aspect of the processing can be defined so that PAV replaces a velocity comparison used in conventional PTV processing with a position comparison. For example, the PINN can be used to calculate x₂ as follows:

$$\frac{dx}{dt} = u ⇔ {x}_{2} ( {x}_{1} , θ ) = {\int }_{{t}_{1}}^{{t}_{2}} u ( θ ) dt + {x}_{1} , \qquad ( 8 )$$

and the advected position is compared to the tracked position, \hat{x}₂, in the PAV data loss term,

$${ℒ}_{data}^{PAV} = \frac{1}{{n}_{p}} {\sum }_{i = 1}^{{n}_{p}} {‖ {\hat{x}}_{2}^{i} - {x}_{2} ( {\hat{x}}_{1}^{i} , θ ) ‖}_{2}^{2} . \qquad ( 9 )$$

Equation (8) may be computed using a variety of numerical schemes, e.g. via forward Euler or Runge-Kutta methods. It should be noted that Eq. (8) also applies to ideal tracer particles, which perfectly follow the flow. Non-ideal effects may be included by explicitly modelling forces on the particle,

$$\frac{{d}^{2} x}{{dt}^{2}} = \frac{{f}_{p}}{m} , \qquad ( 10 )$$

where fₚ is the net force on the particle of mass m.

The above noted PAV data loss in Eq. (9) assumes that the particle positions, \hat{x}₁ and \hat{x}₂ have been perfectly measured. However, these quantities can be subject to large, anisotropic errors that depend on the imaging setup and particle tracking algorithm. Localization errors can act as noise that limits the degree to which the physics loss can be minimized if the positioned are treated as a known quantity. Moreover, such anisotropic errors can lead to biased velocity fields. Equation (6) noted above can be replaced or modified by use of our SPAV approach, which is based on the chance of measuring the particle positions \hat{x}₁ and \hat{x}₂ subject to the velocity field given by θ and the measurement uncertainty. This approach corresponds to the below likelihood probability density function (PDF):

$$P ( {\hat{x}}_{2} \vert {\hat{x}}_{1} , θ ) = \int P ( {\hat{x}}_{2} \vert {x}_{1} , θ ) P ( {x}_{1} \vert {\hat{x}}_{1} ) {dx}_{1} , \qquad ( 11 )$$

which contains two key PDFs. First, P(x₁|\hat{x}₁) is an error model, which describes the probability of a particle being located at x₁ if it was measured at \hat{x}₁. Second, P(\hat{x}₂|x₁, θ) describes the chance of measuring the particle at \hat{x}₂ for a known starting point, x₁, and a velocity field given by θ. The latter PDF contains an error model as well as the advection model from Eq. (8) or (10). Equation (11) can be maximized, so the SPAV data loss, which can be minimized, comprises the sum of negative log likelihoods for each tracked particle,

$${ℒ}_{data}^{SPAV} = - {\sum }_{i = 1}^{{n}_{p}} log [ P ( {\hat{x}}_{2}^{i} \vert {\hat{x}}_{1}^{i} , θ ) ] . \qquad ( 12 )$$

Implementing this loss calculation scheme can also result in use of a model of localization errors. Also, the P(\hat{x}₂ⁱ|\hat{x}₁ⁱ, θ) term can be augmented to include the probability of tracking errors, ghost particles, etc. Any type of error model can be used and incorporated into Eq. (11) for SPAV. We illustrate one such example below as Eq. (13) to provide a multivariate normal (MVN) model as an example of such an error model:

$$P ( x \vert \hat{x} ) = {det ( 2 πΓ )}^{- 1 / 2} exp [ - \frac{1}{2} ( x - \hat{x} \text{?} {Γ}^{- 1} ( x - \hat{x} ) ] , \qquad ( 13 )$$

$$\text{?} \text{indicates text missing or illegible when filed}$$

where x is the (unknown) true particle position, \hat{x} is the measured position, and Γ is the covariance matrix, which describes the magnitude and orientation of measured errors. Many realistic localization errors can be approximated using an MVN PDF. Conveniently, P(x₁|\hat{x}₁) can be directly computed using Eq. (13). The advected particle PDF is obtained by tracing a particle from x₁ to x₂ with Eq. (8) or (10), P(x₂)=P[x₂(x₁, θ)], such that

$$P ( {\hat{x}}_{2} \vert {x}_{1} , θ ) = P [ {\hat{x}}_{2} \vert {x}_{2} ( {x}_{1} , θ ) ] . \qquad ( 14 )$$

For MVN errors, this calculation may be performed using Eq. (13) because MVN model is symmetric, i.e., P(x|\hat{x})=P(\hat{x}|x). Otherwise, separate expressions may need to be provided for the “localization PDF”, P(x|\hat{x}), and the “measurement PDF”, P(\hat{x}|x). These PDFs can be obtained via a numerical or experimental uncertainty quantification (UQ) procedure. Such UQ procedures can include numerical simulation and/or experimental methods.

The SPAV likelihood can be a highly nonlinear function of θ, even when an MVN model is employed to model localization errors. A numerical technique can therefore be utilized for approximating the P(\hat{x}₂|\hat{x}₁, θ) term used in these equations. Below is a discussion of three different approximation techniques that can be utilized for approximating P(\hat{x}₂|\hat{x}₁, θ) for implementation of the SPAV approach.

A first option for approximation of P(\hat{x}₂|\hat{x}₁, θ) can be utilization of a Monte Carlo simulation, which can be done as follows:

$$P ( {\hat{x}}_{2} \vert {\hat{x}}_{1} , θ ) \approx \frac{1}{{n}_{s}} {\sum }_{j = 1}^{{n}_{s}} P ( {\hat{x}}_{2} \vert {\tilde{x}}_{1}^{j} , θ ) , \qquad ( 15 )$$

where nₛ samples of x₁, denoted as \tilde{x}₁, are drawn from P(x₁|\hat{x}₁) and P(\hat{x}₂|\tilde{x}₁, θ) is given by the measurement PDF, P(\hat{x}₂|x₂), evaluated in terms of the advected position, x₂(\tilde{x}₁, θ). While this produces an accurate likelihood PDF for large values of nₛ, it also comes at a significant computational cost. The high cost per particle limits the batch size used in training, which can slow or even prevent the progress of training.

A second option for approximation of P(\hat{x}₂|\hat{x}₁, θ) can be utilization of a MVN approximation. For example, if an MVN error model is suitable and used as noted above and the measurement interval of Δt is small, then the distribution of advected particles can be represented using a rotated and sheared MVN distribution. To do this, samples of x₁ can be drawn from P(x₁\hat{x}₁) and advected using Eq. (8) or Eq. (10) provided above. The mean and covariance of the resulting (presumed) MVN distribution would then be:

$${\hat{μ}}_{2} = \frac{1}{{n}_{s}} {\sum }_{j = 1}^{{n}_{s}} {x}_{2} ( {\tilde{x}}_{1}^{( j )} , θ ) and \qquad ( 16 )$$

$${\hat{Γ}}_{2} = \frac{1}{{n}_{s}} {\sum }_{j = 1}^{{n}_{s}} [ {x}_{2} ( {\tilde{x}}_{1}^{j} , θ ) - {\hat{μ}}_{2} ] [ {x}_{2} ( {\tilde{x}}_{1}^{j} , θ ) - {\hat{μ}}_{2} \text{?} ,$$

$$\text{?} \text{indicates text missing or illegible when filed}$$

such that the advected particle PDF is

$$P ( x \vert {\hat{x}}_{1} , θ ) = {det ( 2 π {\hat{Γ}}_{2} )}^{- 1 / 2} exp [ - \frac{1}{2} ( {x}_{2} - {\hat{x}}_{2} \text{?} {{\hat{Γ}}_{2}}^{- 1} ( {x}_{2} - {\hat{x}}_{2} ) ] . \qquad ( 17 )$$

$$\text{?} \text{indicates text missing or illegible when filed}$$

The expression can be utilized to calculate SPAV PDF,

$$P ( {\hat{x}}_{2} \vert {\hat{x}}_{1} , θ ) = \int P ( {\hat{x}}_{2} \vert {x}_{2} ) P ( {x}_{2} \vert {\hat{x}}_{1} , θ ) {dx}_{2} , \qquad ( 18 )$$

where P(\hat{x}₂|x₂) is given by Eq. (13) because the symmetric MVN error model has been assumed. The convolution of two MVN distributions in Eq. (18) has an exact expression,

$$P ( {\hat{x}}_{2} \vert {\hat{x}}_{1} , θ ) = {det [ 2 π ( Γ + {\hat{Γ}}_{2} ) ]}^{- 1 / 2} exp [ - \frac{1}{2} ( {\hat{x}}_{2} - {\hat{μ}}_{2} \text{?} {( Γ + {\hat{Γ}}_{2} )}^{- 1} ( {\hat{x}}_{2} - {\hat{μ}}_{2} ) ] , \qquad ( 19 )$$

$$\text{?} \text{indicates text missing or illegible when filed}$$

where Γ is the generic measurement uncertainty from Eq. (13). This approximation is more stable than Monte Carlo simulation, but the cost is not significantly lower since many samples are needed for \hat{μ}₂ and \hat{Γ}₂ to converge. Moreover, the advected distribution may not necessarily be a MVN distribution when there is significant vorticity near \hat{x}₁ so there is a complex trade-off that can exist between increased efficiency and reduced accuracy of the MVN approximation when utilizing this second option.

A third option for approximation of P(\hat{x}₂|\hat{x}₁, θ) can be utilization of a fluid element (FE) approximation technique. This approach can be even cheaper than the above noted MNV option in terms of processing resource requirements. This approach can be realized by advecting an ellipsoidal fluid element that can include six points that are located along the principal axes of F, which can be extracted with an eigenvalue decomposition:

$$Q Λ \text{?} = Γ , \qquad ( 20 )$$

$$\text{?} \text{indicates text missing or illegible when filed}$$

where Q=[q₁, q₂, q₃] contains the principal directions of Γ and Λ=diag([λ₁², λ₂², λ₃²]) contains the corresponding variances. A natural choice is to place the points at \hat{x}₁±λ₁q₁, \hat{x}₂±λ₂q₂, and \hat{x}₃±λ₃q₃ and advect them to the next measurement interval,

$${x}_{2}^{+ 1} = {x}_{2} ( {\hat{x}}_{1} + {λ}_{1} {q}_{1} ) , {x}_{2}^{- 1} = {x}_{2} ( {\hat{x}}_{1} - {λ}_{1} {q}_{1} ) , {x}_{2}^{+ 2} = {x}_{2} ( {\hat{x}}_{1} + {λ}_{2} {q}_{2} ) , … \qquad ( 21 )$$

and the advected centroid is taken to be the mean,

$${\hat{μ}}_{2} = \frac{1}{6} ( {x}_{2}^{+ 1} + {x}_{2}^{- 1} + {x}_{2}^{+ 2} + {x}_{2}^{- 2} + {x}_{2}^{+ 3} + {x}_{2}^{- 3} ) . \qquad ( 22 )$$

Next, we collect the advected vertices into a matrix, order them, and perform a singular value decomposition,

$$U \sum \text{?} = [ {x}_{2}^{+ 1} , {x}_{2}^{- 1} , {x}_{2}^{+ 2} , {x}_{2}^{- 2} , {x}_{2}^{+ 3} , {x}_{2}^{- 3} ] - {\hat{μ}}_{2} \text{?} , \qquad ( 23 )$$

$$\text{?} \text{indicates text missing or illegible when filed}$$

where 1 is a 6×1 vector of ones. Lastly, these elements are used to estimate the advected covariance matrix,

$${\hat{Γ}}_{2} = \frac{1}{2} \text{?} {\sum }^{o 2} U , \qquad ( 24 )$$

$$\text{?} \text{indicates text missing or illegible when filed}$$

where (⋅)^{o2} is a Hadamard exponent, which is applied to each element of the matrix. Given \hat{μ}₂ and \hat{Γ}₂ from Eqs. (22) and (24), Eq. (19) may be used to compute the SPAV likelihood PDF. This procedure is less accurate than Monte Carlo or sample based MVN techniques, but it is also hundreds to thousands of times cheaper, dramatically increasing the maximum batch size.

The above noted fluid element technique can be conducted using multiple ellipsoids with distinct radii. Such ellipsoids can be weighted by distance from the centroid to help stabilize the technique in regions of high vorticity.

Referring again to FIG. 2, other exemplary embodiments of the at least one computer device 3 can be configured as a combination of differentiable flow and particle surrogate models. FIG. 2 illustrates the overall framework, which may be implemented in a differentiable programing environment. In this example, flow states are represented using a neural network and particle tracks may be represented using numerical integration or a polynomial form. PAV and SPAV algorithms can each be formulated for both parameterizations of the particle tracks.

The flow model comprises a neural network and the particle model consists of a series of data-constrained polynomials. The combined flow and particle model can be configured to utilize a pre-defined PAV or SPAV algorithm. In some embodiments, the two surrogate models can be configured to simultaneously estimate, e.g., velocity, pressure, density and other fields of the flow of fluid 4 from error-laden and/or inertial tracer particle positions obtained via the camera 9. The neural network can function to provide a low-cost representation of the carrier fluid as a mathematical functional whose form can be optimized in an unsupervised configuration using standard deep learning tools, for example.

Simultaneous training of the flow and particle models can be based on a loss function that contains a “physics loss” to approximately satisfy the equations governing the carrier fluid (e.g. Navier-Stokes equations), a physics loss to approximately satisfy the equations governing the motion of particles (e.g. Maxey-Riley equation), and a “data loss” to ensure an appropriate statistical fit of the estimated particle positions and measured PTV data. The data loss aspect can utilize an explicit particle advection model to capture particle trajectories that may include non-ideal effects (e.g. Stokes drag, thermophoresis), which can expand the types of flows that can be reliably measured. Particle advection may also be implicitly incorporated into the particle model as a hard constraint. These advection approaches which model transport of the particles can be referred to as particle advection velocimetry (PAV). Furthermore, the particle advection schemes can be formulated using a statistical approach to compensation for arbitrary particle localization uncertainties. This statistical approach can be referred to as stochastic particle advection velocimetry (SPAV). The SPAV can be a type of PAV algorithm. The SPAV that is utilized can be defined to be a flexible framework that can accommodate various PTV modalities and can greatly improve the accuracy of velocity, pressure, and other flow field estimates at a reasonable computational cost. The defined SPAV or PAV can be defined by code stored in a non-transitory memory of the at least one computer device 3 (or the computer device(s) of the PINN, for example) so that the SPAV or PAV is performed when a processor runs that stored code.

### Neural Network Flow Model

Coordinate neural networks used to represent flow states in conjunction with explicit physics-based equations for this exemplary embodiment are called PINNs, i.e. “physics-informed neural networks”. Although there are numerous methods to represent flow states for PTV data assimilation, a specific instantiation that uses a PINN is described here for this example because PINNs can provide advantages in the context of flow reconstruction, e.g.: (a) PINNs are easy to implement, (b) PINNs offer significant data compression compared to grid-based methods, and (c) PINNs provide a mesh-free, analytical representation of flow states and their derivatives, which is ideal for numerical optimization algorithms. A PINN, here represented by F, maps spatial locations, x, and times, t, to states of flow of fluid 4 at the location x and time t,

$$ℱ ( {θ}_{f} ) : ( x , t ) ↦ ( {u}_{f} , {p}_{f} , {ρ}_{f} , … ) , \qquad ( 25 )$$

where u_{f}, p_{f}, and ρ_{f} are the carrier phase velocity, pressure, and density fields and θ_{f} is a vector of network parameters, for example, weights, biases, and other parameters. Additional output fields can be added as well to account for other flow variables of interest, so long as they are included in the governing equations or are related to a sensor signal that may be included in a data loss.

In general, a PINN may comprise an input layer, output layer, and series of n₁ hidden layers,

$$ℱ ( {z}^{0} ) = {W}^{{n}_{1} + 1} [ {𝒩}^{{n}_{1}} ∘ {𝒩}^{{n}_{1} - 1} ∘ … ∘ {𝒩}^{2} ∘ 𝒢 ( {z}^{0} ) ] + {b}^{{n}_{1} + 1} , \qquad ( 26 )$$

$$with$$

$${z}^{l} = {𝒩}^{l} ( {z}^{l - 1} ) = σ ( {W}^{l} {z}^{l - 1} + {b}^{l} ) for l ∈ \{ 2 , 3 , … , {n}_{l} \} . \qquad ( 27 )$$

Here, the vector z^{l} contains the value of neurons in the lth layer, W^{l} and b^{l} are the weight matrix and bias vector for the lth layer, and σ is a nonlinear activation function. In this example, the vector θ_{f} contains all the elements of W^{l} and b^{l} for values of l ranging from 2 to n₁+1. Of the many possible activation functions, swish functions are a suitable choice suitable for PINNs,

$$σ ( z ) = \frac{z exp ( z )}{1 + exp ( z )} , \qquad ( 28 )$$

This form has been shown to improve stability of gradient flow in training compared to other popular activation functions for PINNs. To mitigate the spectral bias of gradient-descent-type training, the [symbol] layer can be replaced with a Fourier encoding,

$${z}^{1} = 𝒢 ( {z}^{0} ) = {[ sin ( 2 {πω}_{1} \cdot {z}^{0} ) , cos ( 2 {πω}_{1} \cdot {z}^{0} ) , … , sin ( 2 {πω}_{ω} \cdot {z}^{0} ) , cos ( 2 {πω}_{ω} \cdot {z}^{0} ) ]}^{T} . \qquad ( 29 )$$

In this layer, ω is the number of Fourier features and ω is a vector of random frequencies, which are fixed before training, with a unique frequency for each element of z⁰. When creating a Fourier layer, [symbol] , the frequencies in ω are often drawn from a zero-mean Gaussian distribution at the outset of training.

### Numerical Advection of Particles

A track measured by PTV comprises of a sequence of particle locations,

$$\{ {x}_{0}^{k} , {x}_{1}^{k} , … , {x}_{{n}_{k} - 1}^{k} \} ,$$

where the variable k is the track index and nₖ is the number of positions recorded along the track. One straightforward way to incorporate the physics of particle advection in a PTV reconstruction algorithm is to perform numerical advection of the flow. By definition, the particle velocity can satisfy the following expression,

$$\frac{dx}{dt} = {v}_{p} , \qquad ( 30 )$$

where vₚ is the velocity of the particle. In cases where the particles are assumed to perfectly follow the flow, vₚ=u_{f}, where the latter quantity is given by the PINN, [symbol] , and as a result Eq. (30) may be implemented as follows:

$${θ}_{x , j}^{k} = {\int }_{{t}_{j - 1}}^{{t}_{j}} {u}_{f} [ x ( t ) ; {θ}_{f} ] dt + {x}_{j - 1}^{k} for j = 1 , 2 , … , {n}_{k} - 1. \qquad ( 31 )$$

In this expression,

$${θ}_{x , j}^{k}$$

is the advected location of the kth particle at the jth step, u_{f} is the carrier fluid velocity as represented by the PINN with parameters θ_{f}, and x(t) is the solution to the ordinary differential equation (ODE) in Eq. (31) when it is initialized at the (j−1)th position of the kth track, i.e.

$${x}_{j - 1}^{k} .$$

The quantity

$${θ}_{x , j}^{k}$$

forms the jth column of a matrix, denoted

$${θ}_{x}^{k} ,$$

which includes an estimate of all the advected positions in the kth particle track, i.e. for j=1, 2, . . . , nₖ−1. It is convenient to aggregate estimates for all the particles into a rank 3 tensor,

$${Θ}_{x} = [ {θ}_{x}^{1} , {θ}_{x}^{2} , … {θ}_{x}^{{n}_{p}} ] ,$$

where nₚ is the total number of particle tracks.

Equation (31) can be solved numerically. Example solution schemes include the forward Euler and various Runge-Kutta methods. Such an approach to particle advection can be implemented and can apply when the particles behave as ideal tracers, but it can be difficult to incorporate inertial effects into this formulation since it relies on the equivalence of the carrier fluid and particle velocities, u_{f} and vₚ. For inertial particles, whose velocity may depart from that of the local fluid flow, a dedicated particle model based approach can be specified and its output can obey a physical equation of motion for the particles.

### Data-Constrained Polynomial Particle Model

One instantiation of such a particle model involves a set of polynomial functions, [symbol] , with one function for each particle. The function [symbol] describes the velocity of the kth particle as a continuous function of time,

$${𝒫}^{k} ( {θ}_{p}^{t} ) : t ↦ {v}_{p} for k ∈ \{ 1 , 2 , … , {n}_{p} \} , \qquad ( 32 )$$

where

$${θ}_{p}^{k}$$

is a vector of polynomial coefficients for the kth track. A trainable vector of properties, ψ^{k}, may also be specified for each particle; this vector can include any particle properties of interest that affect the particle's trajectory, such as the particle size, density, charge, etc. In a well-characterized PTV experiment, where all the salient particle properties are known in advance or can be determined from the image data, ψ^{k} is omitted. All the trajectory coefficients and particle properties may be collected in matrices, denoted Θₚ and Ψ, respectively.

It is possible to construct a particle track model such that the advection equation given in Eq. (31) is explicitly enforced through the formulation of [symbol] , as described below. In the following exposition, a single component of velocity, νₚ, is presented for a single particle, so the particle index, k, is dropped from the notation for the rest of this section. The extension to 2D and 3D polynomials is also able to be provided.

Following the theory of functional connections, which is a general framework for converting a constrained optimization problem into an unconstrained one, a particle's velocity may be represented as follows:

$${𝒫}^{k} ≡ {v}_{p} ( t ) = g ( t ) + {\sum }_{j = 1}^{{n}_{c}} {η}_{j} {φ}_{j} ( t ) . \qquad ( 33 )$$

In this expression, g is an unconstrained “free function” that is once integrable and differentiable, nⱼ is a projection coefficient that enforces Eq. (31) for any function g, φⱼ is a switch function that integrates to unity within the jth interval and zero elsewhere, and n_{c}=nₖ−1 is the number of constraints for the track, i.e., the number of intervals between adjacent tracked positions. All the free parameters are embedded in g, which can be set to be a pth-order polynomial in time,

$$g ( t ) = {\sum }_{i = 0}^{p} {θ}_{i} {t}^{i} . \qquad ( 34 )$$

Note that the coefficients θᵢ make up the trainable vector θₚ. In practice, p=nₖ+2 ensures that g can adequately represent the vast majority of particle tracks. The jth projection coefficient is

$${η}_{j} = ( {x}_{j} - {x}_{j - 1} ) - {\int }_{{t}_{j - 1}}^{{t}_{j}} g ( t ) dt , \qquad ( 35 )$$

which corresponds to the integral constraint in Eq. (31), and the jth switch function is

$${φ}_{j} ( t ) = {\sum }_{i - 1}^{{n}_{c}} {s}_{i} ( t ) {A}_{i , j} , \qquad ( 36 )$$

where sᵢ is the ith so-called support function and A_{i,j} is a weighting coefficient. Equation (36) ensures that the nⱼ constraints are correctly applied as a function of time. This objective corresponds to the following condition,

$${\int }_{{t}_{ι - 1}}^{{t}_{ι}} {φ}_{j} ( t ) dt = \{ \begin{matrix}1 , & i = j \\ 0 , & i \neq j\end{matrix} \qquad ( 37 )$$

for all i and j in {1, 2, . . . , n_{c}}, culminating in a linear system with three n_{c}×n_{c} matrices,

$$SA = I . \qquad ( 38 )$$

In this system, the matrix S has elements

$${S}_{i , j} = {\int }_{{t}_{ι - 1}}^{{t}_{ι}} {s}_{j} ( t ) dt , \qquad ( 39 )$$

A comprises the coefficients A_{i,j}, and I is the identity matrix. Support functions can be selected to ensure that S is non-singular, but they are otherwise arbitrary. A common choice is monomial support functions: sⱼ(t)=t^{j-1}.

Given a set of support functions, the coefficients in A are computed by solving Eq. (38). This step is independent of the form of g and coefficients in θₚ. Conversely, the projection coefficients, nⱼ, can be adjusted as a function of θₚ to preserve the integral constraints in Eq. (35). For the polynomial free function in Eq. (34), a closed form expression for nⱼ can be obtained by substituting Eq. (34) into Eq. (35). To simplify the implementation of [symbol] , the track polynomials can be written in matrix form. First, several notations are specified: a time vector,

$$τ ( t ) = {\{ {t}^{i} \}}_{i = 0}^{p} ;$$

a displacement vector,

$$δ = {\{ {x}_{j} - {x}_{j - 1} \}}_{j = 1}^{{n}_{c}} ;$$

a p+1×n_{c} support matrix, C, with elements

$${C}_{i , j} = {i}^{- 1} ( {t}_{j}^{i} - {t}_{j = 1}^{i} ) , \qquad ( 40 )$$

where

$${t}_{j}^{i}$$

the jth timestep, tⱼ, raised to the ith power; and an n_{c}×p+1 augmented weight matrix, Â=[A;0]^{T}. Using these elements, Eq. (33) becomes

$${v}_{p} ( t ) = [ {θ}_{p}^{T} ( I - C \hat{A} ) + {δ}^{T} \hat{A} ] τ ( t ) . \qquad ( 41 )$$

The resulting function is a continuous representation of velocity that inherently satisfies Eq. (33) for any θₚ and can be rapidly evaluated in a differentiable computing environment. Note that the displacement vector δ can be written in terms of the track matrix, θₓ, so Eq. (41) can feature variable velocities, specified in terms of θₚ, that integrate to the track positions in θₓ.

### General Governing Equations for Disperse Multiphase Flow

For a generic PTV scenario, the carrier phase flow can be described in terms of the compressible continuity, momentum, and energy equations:

$$\frac{\partial {ρ}_{f}}{\partial t} + ∇ \cdot ( {ρ}_{f} {u}_{f} ) = 0 , \qquad ( 42 )$$

$$\frac{\partial ( {ρ}_{f} {u}_{f} )}{\partial t} + ∇ \cdot ( {ρ}_{f} {u}_{f} {u}_{f}^{T} ) = - ∇ {p}_{f} + ∇ \cdot [ {μ}_{f} ( ∇ {u}_{f} + ∇ {u}_{f}^{T} ) - \frac{2}{3} {μ}_{f} ( ∇ \cdot {u}_{f} ) I ] ,$$

$$and$$

$$\frac{\partial ( {ρ}_{f} {E}_{f} )}{\partial t} + ∇ \cdot [ ( ρ {E}_{f} + {p}_{f} ) {u}_{f} ] = ∇ \cdot ( {κ}_{f} ∇ {T}_{f} ) + ∇ \cdot \{ [ {μ}_{f} ( ∇ {u}_{f} + ∇ {u}_{f}^{T} ) - \frac{2}{3} {μ}_{f} ( ∇ \cdot {u}_{f} ) I ] \cdot {u}_{f} \} .$$

In these expressions, the subscript “f” denotes a variable related to the carrier fluid: u_{f} is the velocity vector, p_{f} is pressure, ρ_{f} is density, μ_{f} is dynamic viscosity, E_{f} is total energy, T_{f} is temperature, and κ_{f} is thermal conductivity. Note that T_{f} can be determined by the fluid's local total energy and velocity magnitude, and one may calculate the dynamic viscosity and thermal conductivity via an appropriate relation, such as Sutherland's Law. Equation (42) contains four equations and five unknowns and can be closed with an equation of state, e.g.

$${p}_{f} = ( {γ}_{f} - 1 ) {ρ}_{f} {\underbrace{( {E}_{f} - \frac{1}{2} {u}_{f} \cdot {u}_{f} )}}_{{C}_{V} {T}_{f}} , \qquad ( 43 )$$

where γ_{f} is the ratio of specific heats for the carrier phase and Cᵥ is the specific heat by constant volume.

Small spherical particles moving in locally uniform flow are subject to inertial and viscous effects. Inertial transport regimes are often delineated in terms of the particle Reynolds number, defined with respect to a particle length scale, slip velocity, and fluid viscosity,

$$R {e}_{p} = \frac{{ρ}_{f} {d}_{p} {\overbrace{\vert {u}_{f} - {v}_{p} \vert}}^{slip}}{{μ}_{f}} . \qquad ( 44 )$$

where dₚ denotes particle diameter. Slip, a.k.a. lagging or ballistic transport, is characterized in terms of a response time,

$${τ}_{p} = \frac{4}{3 {C}_{D} R {e}_{p}} \frac{{ρ}_{p} {d}_{p}^{2}}{{μ}_{f}} , \qquad ( 45 )$$

where C_{D} is the drag coefficient. The form of C_{D} has been studied extensively for spherical particles and can be expressed as a function of the particle characteristics and surrounding flow conditions. Expressions for C_{D} are typically presented in terms of a particle-based Reynolds number (Eq. (20)), Mach number, and Knudsen number, which account for viscous, compressibility, and rarefaction effects, respectively. Other modifications of C_{D} have also been proposed to incorporate drag effects related to the particle geometry and surface roughness.

For particles that are smaller than the relevant hydrodynamic length scale, their motion in flows can be described by the extended Maxey-Riley equation,

$$\frac{{d v}_{p}}{d t} = \frac{{\overbrace{\vert {u}_{f} - {v}_{p} \vert}}^{I}}{{τ}_{p}} + {\overbrace{\frac{{ρ}_{f}}{{ρ}_{p}} \frac{{D u}_{f}}{D t}}}^{II} + {\overbrace{\frac{1}{{ρ}_{p}} {\int }_{- ∞}^{t} {{K}_{a d} ( t - τ ) [ \frac{D ( {ρ}_{f} {u}_{f} )}{D t} - \frac{d ( {ρ}_{f} {v}_{p} )}{d t} ]}_{t - τ} d τ}}^{III} \text{} + {\underbrace{\frac{9}{{d}_{p} {ρ}_{p}} \sqrt{\frac{{ρ}_{f} {μ}_{f}}{π}} {\int }_{- ∞}^{t} {{K}_{b s} ( t - τ ) [ \frac{D ( {ρ}_{f} {u}_{f} )}{D t} - \frac{d ( {ρ}_{f} {v}_{p} )}{dt} ]}_{t - τ} d τ}}_{IV} + b , \qquad ( 46 )$$

where ρₚ is particle density, D/Dt and d/dt are the total derivatives defined with respect to a fluid parcel and particle, respectively, and K_{ad} and K_{ad} are the added mass and Basset history force kernels. As with C_{D}, these kernels are functions of the particle Reynolds and Mach numbers. Terms on the right side of this expression represent the (I) Stokes (a.k.a. quasi-steady viscous) drag, (II) pressure gradient, (III) added mass, and (IV) Basset history force; all the relevant body forces are aggregated in b.

### Objective Loss for Optimization

Ideally, the flow states from [symbol] and particle trajectories implied by numerical advection, the data-constrained tracks, [symbol] , or similar should obey the governing equations, satisfy known boundary conditions, and match experimental data. Consistency with the PTV data can be guaranteed by hard constraints on [symbol] or promoted via comparison of the tracked locations and estimated positions,

$${θ}_{x}^{k} ,$$

for all the particles. These goals may be encoded in an objective loss:

$${ℒ}_{total} = ( {θ}_{f} , {Θ}_{p} , {Θ}_{x} , Ψ ) = {χ}_{1} {ℒ}_{phys}^{flow} ( {θ}_{f} ) + {χ}_{2} {ℒ}_{phys}^{part} ( {Θ}_{p} , {Θ}_{x} , Ψ ) + {χ}_{3} {ℒ}_{b o u n d} ( {θ}_{f} ) + {χ}_{4} {ℒ}_{data} ( {Θ}_{x} ) , \qquad ( 47 )$$

where χ₁, χ₂, χ₃, and χ₄ are loss weighting parameters that can be carefully selected. The flow physics loss is

$${ℒ}_{phys}^{flow} ( {θ}_{f} ) = \frac{{d}_{f}^{- 1}}{\vert \times 𝒯} {\int }_{𝒯} \int {\int }_{} \int {‖ {e}_{f} ( x , t ; {θ}_{f} ) ‖}_{2}^{2} d dt . \qquad ( 48 )$$

In this expression, [symbol] and [symbol] are the spatial and temporal domains, e_{f} is a vector of that contains the residuals from Eq. (42), evaluated using the flow state from [symbol] at (x, t) via the network parameters θ_{f}, and d_{f} is the number of equations for the carrier phase, i.e. the dimension of e_{f}. The vector e_{f} in Eq. (48), contains the residual from each component of Eq. (42). Similarly, the particle physics loss is

$${ℒ}_{phys}^{part} ( {Θ}_{p} , {Θ}_{x} , Ψ ) = \frac{{d}_{p}^{- 1}}{{n}_{p}} [ {\sum }_{k = 1}^{{n}_{p}} {\int }_{{𝒯}^{k}} {‖ {e}_{p}^{k} ( t ; {θ}_{p}^{k} , {θ}_{x}^{k} , {ψ}^{k} ) ‖}_{2}^{2} dt ] , \qquad ( 49 )$$

where [symbol] ⊂ [symbol] is the time segment for the kth track and

$${e}_{p}^{k}$$

is a vector of residuals from Eq. (46), evaluated using [symbol] and numerical advection, the data-constrained polynomials, [symbol] , or similar, for the kth particle at time t via the parameters θ_{f},

$${θ}_{p}^{k} ,$$

and ψ^{k}, and dₚ is dimension of

$${e}_{p}^{k} .$$

The vector

$${e}_{p}^{k}$$

in Eq. (49), contains the residual from each component of Eq. (46), for the kth particle. Boundary losses depend on the specific condition, for instance, a no-slip wall corresponds to the following loss:

$${ℒ}_{bound} ( {θ}_{f} ) = \frac{{d}_{u}^{- 1}}{\vert \times 𝒯 \vert} {\int }_{𝒯} {\int \int }_{} {‖ {u}_{f} ( x , t ; {θ}_{f} ) ‖}_{2}^{2} d dt , \qquad ( 50 )$$

where dᵤ is the dimension of u_{f} and [symbol] is the wall surface. Partial derivatives of [symbol] , [symbol] , and other models may be obtained by automatic differentiation and used to determine e_{f} and

$${e}_{p}^{k}$$

by evaluating the governing equations. Integrals in Eqs.(48) to (50) can be computed by Monte Carlo sampling. Lastly, advected particle locations can be compared with PTV data (e.g. camera images obtained from the camera 9, particles localized from camera images obtained from the camera 9, etc.) through a PAV “data loss”, as an example,

$${ℒ}_{data}^{PAV} ( {Θ}_{x} ) = \frac{1}{{n}_{p}} {\sum }_{k = 1}^{{n}_{p}} \frac{1}{{n}_{k} - 1} {\sum }_{j = 1}^{{n}_{k} - 1} {‖ {θ}_{x , j}^{k} - {x}_{j}^{k} ‖}_{2}^{2} . \qquad ( 51 )$$

The PAV data loss is inherently satisfied by the data-constrained tracks but it can be explicitly included in the optimization when using the numerical advection scheme. Ultimately, the overall objective loss [symbol] ₜₒₜₐₗ is minimized using, for example, a backpropagation algorithm, resulting in an approximate solution to the governing equations that satisfies or approximately satisfies the PTV data (e.g. particulate trajectories which were observed via the images taken by the camera 9, particles localized from camera images obtained from the camera 9, etc.), depending on the chosen advection scheme.

### Stochastic PAV

Use of the PAV data loss in Eq. (51) can be premised on the tacit assumption that the particle positions,

$${x}_{j}^{k} ,$$

have been perfectly measured. However, these quantities can be subject to large, anisotropic errors that depend on the imaging setup and particle tracking algorithm. Localization errors can act as noise that limits the degree to which the physics loss can be minimized if the positioned are treated as a known quantity. Moreover, such anisotropic errors can lead to biased velocity fields. Equation (51) may be augmented to obtain a stochastic PAV method, which is based on the chance of measuring the particle positions

$${x}_{j}^{k}$$

subject to the velocity field given by [symbol] and the measurement uncertainty.

A general SPAV data loss can be formulated using the likelihood probability density function (PDF) of observing a measured particle,

$${x}_{j}^{k} ,$$

given the advected particle location,

$${θ}_{x , j}^{k} ,$$

denoted as

$$P ( {x}_{j}^{k} \vert {θ}_{x , j}^{k} ) .$$

### Here,

$${θ}_{x , j}^{k}$$

is obtained by numerical advection or, in the case of data-constrained polynomials, it is a trainable variable. Assuming the PDFs for each particle are independent, one can define a SPAV data loss to be the negative log of the likelihood for the whole population of particles,

$${ℒ}_{data}^{SPAV} ( {Θ}_{x} ) = - {\sum }_{k = 1}^{{n}_{p}} {\sum }_{j = 1}^{{n}_{k} - 1} P ( {x}_{j}^{k} \vert {θ}_{x , j}^{k} ) . \qquad ( 52 )$$

### Computation of

$$P ( {x}_{j}^{k} \vert {θ}_{x , j}^{k} )$$

depends on the distribution of localization errors, i.e. a PDF that describes the probability density of the true value locating a particle at

$${x}_{j}^{k}$$

if the true location is

$${θ}_{x , j}^{k} .$$

While any formal PDF can be combined with Eq. (52) for this purpose, the multivariate normal (MVN) model is a suitable choice for particle localization errors,

$$P ( x \vert \hat{x} ) = {det ( 2 π Γ )}^{1 / 2} exp [ - \frac{1}{2} {( x - \hat{x} )}^{T} {Γ}^{1} ( x - \hat{x} ) ] , \qquad ( 53 )$$

where x is a measured position, \hat{x} is the (unknown) true particle position, and Γ is the covariance matrix, which describes the magnitude and orientation of measurement errors. This MVN model can be called a “measurement PDF”.

When using data-constrained tracks, the displacement vector δ in Eq. (41) may be specified in terms of a trainable particle location parameter, θₓ, allowing the user to infer the correct particle position during optimization. When θₓ is allowed to vary and the measurement locations are subject to error, there is a trade-off between satisfying the SPAV data loss and the physics losses. Therefore, the optimization algorithm may be able to find an improved compromise between the physical equations and track data by allowing θₓ to be optimized and accounting for the distribution of measurement errors.

When using numerical advection instead of data-constrained polynomials, the PDF

$$P ( {x}_{j}^{k} \vert {θ}_{x , j}^{k} )$$

in Eq. (52) can be formulated as follows:

$$P ( {x}_{j}^{k} \vert {θ}_{x , j}^{k} ) ≡ P ( {x}_{j}^{k} \vert {x}_{j - 1}^{k} , {θ}_{f} ) = \int P ( {x}_{j}^{k} \vert {x}_{j - 1} , {θ}_{f} ) P ( {x}_{j - 1} \vert {x}_{j - 1}^{k} ) {d x}_{j - 1} . \qquad ( 54 )$$

In this expression

$$, P ( {x}_{j - 1} \vert {x}_{j - 1}^{k} ) ,$$

is an error model that describes the probability of a particle being located at xⱼ₋₁ if it was measured at

$${x}_{j - 1}^{k}$$

and therefore can be referred as “localization PDF”. For MVN errors, this PDF may be calculated using Eq. (53) because MVN model is symmetric, i.e., P(x|\hat{x})=P(\hat{x}|x). Otherwise, separate expressions need to be provided for the “localization PDF”, P(\hat{x}|x), and the “measurement PDF”, P(x|\hat{x}). The second distribution,

$$P ( {x}_{j}^{k} \vert {x}_{j - 1} , {θ}_{f} ) ,$$

describes the chance of measuring the particle at

$${x}_{j}^{k}$$

for a known starting point, xⱼ₋₁, and a velocity field given by θ_{f}. The latter PDF contains an error model as well as the advection model from Eq. (31). This term can also be augmented to include the probability of tracking errors, ghost particles, etc. The advected particle PDF is obtained by tracing a particle from xⱼ₋₁ to

$${θ}_{x , j}^{k}$$

with Eq. (31),

$$P ( {θ}_{x , j}^{k} ) = P [ {θ}_{x , j}^{k} ( {x}_{j - 1} , {θ}_{f} ) ] ,$$

such that

$$P ( {x}_{j}^{k} \vert {x}_{j - 1} , {θ}_{f} ) = P [ {θ}_{j}^{k} \vert {θ}_{x , j}^{k} ( {x}_{j - 1} , {θ}_{f} ) ] . \qquad ( 55 )$$

The right side of Eq. (55) is essentially the particle likelihood defined in Eq. (52), which may also be calculated with Eq. (53) if assumed as MVN errors. These PDFs can be obtained via a numerical or experimental uncertainty quantification (UQ) procedure. Such UQ procedures can include numerical simulation and/or experimental methods.

The SPAV likelihood can be a highly nonlinear function of θ_{f}, even when an MVN model is employed to model localization errors. A numerical technique can therefore be utilized for approximating the

$$P ( {x}_{j}^{k} \vert {x}_{j - 1}^{k} , {θ}_{f} )$$

PDF in these equations. All three approximations included in the previous description of an embodiment of our system and process, i.e., Markov Chain sampling, a full multivariante normal approximation, and a fluid element approximation, can be used to execute SPAV in conjunction with numerical advection using the presently described embodiment.

Our above discussed PAV and SPAV approaches are new approaches for processing particle position data that can be implemented via at least one computer device 3. Most conventional PTV methods use a much more complex numerical scheme to calculate the pressure field from an estimated Lagrangian velocity data, which typically results in an unstable and costly procedure that is also prone to corruption due to localization and tracking errors.

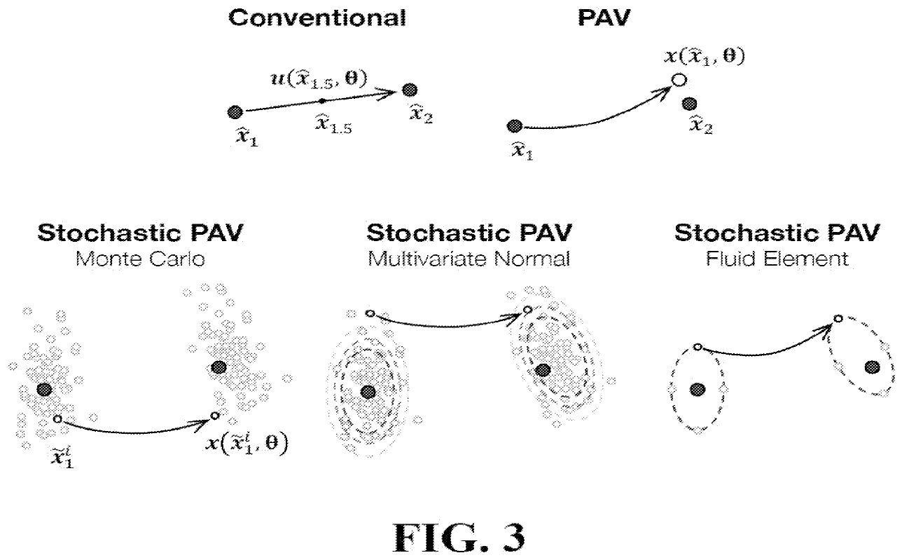

FIG. 3 illustrates comparisons of data loss terms that can be provided by a conventional approach as compared to the PAV and SPAV approaches discussed above to help further illustrate the distinct differences that are provided by embodiments of our PAV and SPAV approaches as compared to a conventional approach. The PAV and SPAV approaches can account for non-ideal tracers and the SPAV approaches can further account for highly anisotropic localization and tracking errors that can arise. In contrast, the conventional approach is adversely affected by errors resulting from a reliance on Lagrangian velocity data, use of complex numerical schemes, and other above-mentioned errors.

### EXAMPLES

We performed testing of embodiments of our PAV and SPAV based approaches using simulated particle trajectories through a known flow of fluid and compared the performance of embodiments of our methods and system that were tested to a conventional technique using noise-free particle tracks as well as tracks that were corrupted by anisotropic errors to evaluate embodiments of our method and system and how they compared to existing options.

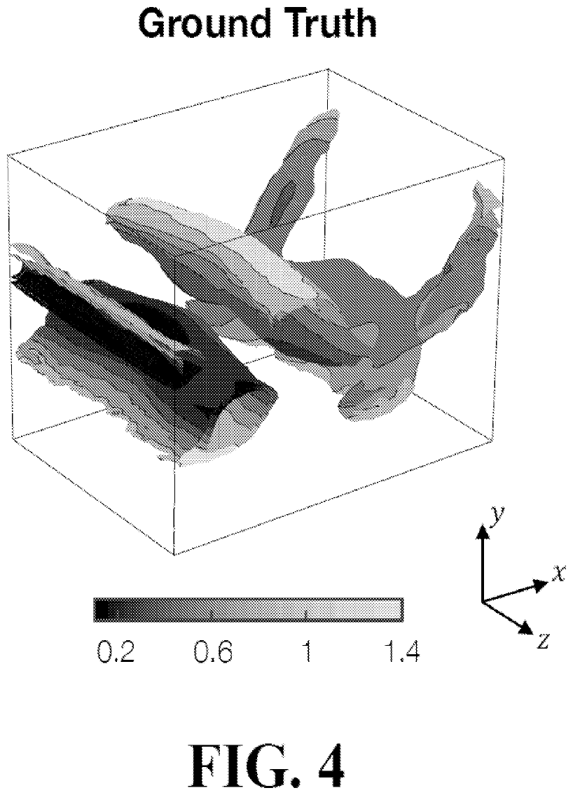

For the setup of our simulation work, flow data for the simulated was obtained from a direct numerical simulation (DNS) of flow over a cylindrical bluff body using the 3D incompressible Navier-Stokes equations that was performed by M. Raissi et al. and reported in “Hidden fluid mechanics: Learning velocity and pressure fields from flow visualizations”, Sc. 367, 1026-1030 (2020). This data included unsteady velocity and pressure fields in the wake of a cylindrical bluff body and the resulting flow had a Reynolds number of 100. The computational domain of interest was a 7×7×5 (dimensionless) region behind the cylinder. This region was discretized into 71×51×51 elements and simulated for 201 timesteps. Sample ground truth data from the DNS data that we obtained is provided in FIG. 4.

To generate synthetic particle tracks, we randomly positioned 1000 virtual particles throughout the flow domain and presumed them to be ideal tracers so Eq. (8) was employed to advect each one. This procedure was implemented by way of the second order Runge-Kutta method and periodic boundary conditions were applied to keep the number of particles constant throughout the conducted testing. Resulting trajectories were fed to different PTV algorithms to assess their performances with respect to the accuracy of velocity and pressure field reconstructions.

In this testing, all our PINNs were implemented using the software package TensorFlow 1.14. The networks included ten hidden layers, each containing 50 neurons per output variable. Swish activation functions were selected based on their well-known performance characteristics in the context of PINNs. Weights were randomly initialized with a standard normal distribution and biases were set to zeros at the start of the testing. Training was performed using the Adam optimizer at a fast learning rate of 1×10⁻³ and a slow rate of 1×10⁻⁴. We tested two non-statistical data loss terms: (1) a conventional PTV data loss (Eq.(6)) and (2) our PAV approach (the advection based loss of Eq.(9)). We also tested three approximations to our SPAV approach, (3) SPAV (MC)—a Monte Carlo approximation to the SPAV loss (Eq. (15)), (4) SPAV (MVN)—a multivariate normal SPAV loss (Eq. (19)), and (5) SPAV (FE)—a fluid element based SPAV loss (Eq. (19) via Eqs. (22) and (24)). Note: SPAV (MC) is also referred to as SPAV-MC, SPAV (MVN) is also referred to as SPAV-MVN and SPAV (FE) is also referred to as SPAV-FE herein.

We used a batch size of 10,000 for the conventional and PAV PINNS, which were trained for 5,000 epochs at the fast learning rate followed by 1,000 epochs at the slow rate. Batch sizes for the SPAV PINNs were limited by available GPU memory: we used a batch size of 100 for the SPAV (MC) and SPAV (MVN) PINNs and 2,000 for the SPAV (FE) PINN. Due to the small batch size, the SPAV (MC) and SPAV (MVN) PINNS were only trained for 100 epochs at the fast rate and 20 epochs at the slow rate. The SPAV (FE) PINN was trained for 2,000 epochs at the fast rate and 400 epochs at the slow rate. These training schedules were sufficient to ensure convergence. The average computation time was around ten hours for the conventional and PAV PINNs and was 20 hours for the SPAV approaches.

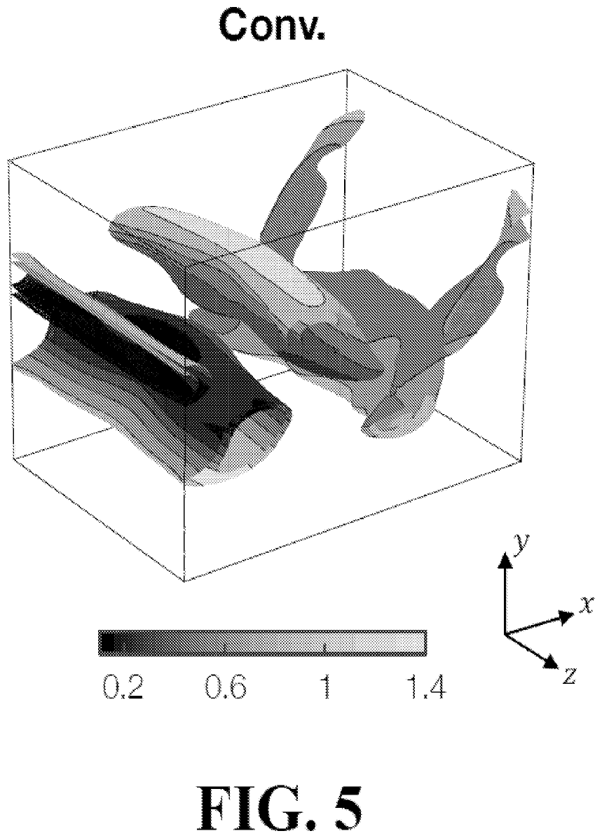

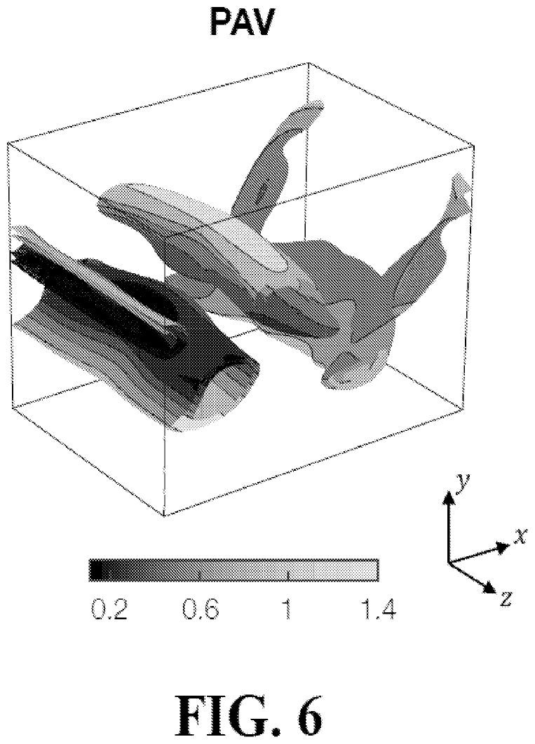

Once the setup was complete, we conducted a set of noise-free tests to compare performance of a conventional PINN to a PINN utilizing an embodiment of our PAV approach under ideal conditions in which particle tracks were perfectly known. A single snapshot of the ground truth is shown in FIG. 4 and the reconstructed velocity fields from the conventional approach (FIG. 5) and the PAV approach (FIG. 6) are shown in FIGS. 5 and 6. These results showed that the PAV methodology was able to correctly reconstruct the vortical structures downstream of the cylinder to confirm the validity of the PAV scheme. Quantitative results from this testing are summarized in Table 1, which lists the normalized Euclidean error of each velocity component and pressure averaged over the entire 4D computational domain (x, y, z, and time, t). As with the qualitative visualization, the low errors show that the PAV scheme worked well.

TABLE 1
Velocity and pressure errors from the noise-free tests

| Method | eᵤ, % | eᵥ, % | e_{w}, % | eₚ, % |
|---|---|---|---|---|
| conv | 0.7 | 2.0 | 5.6 | 3.0 |
| PAV | 0.6 | 1.9 | 5.3 | 2.9 |

We then performed noisy tests to evaluate how embodiments of our process and system would work in conjunction with less ideal situations that are more practically experienced in real-world situations. Such errors can be particularly severe and can result in significant problems (e.g. reconstruction artifact problems, etc.).

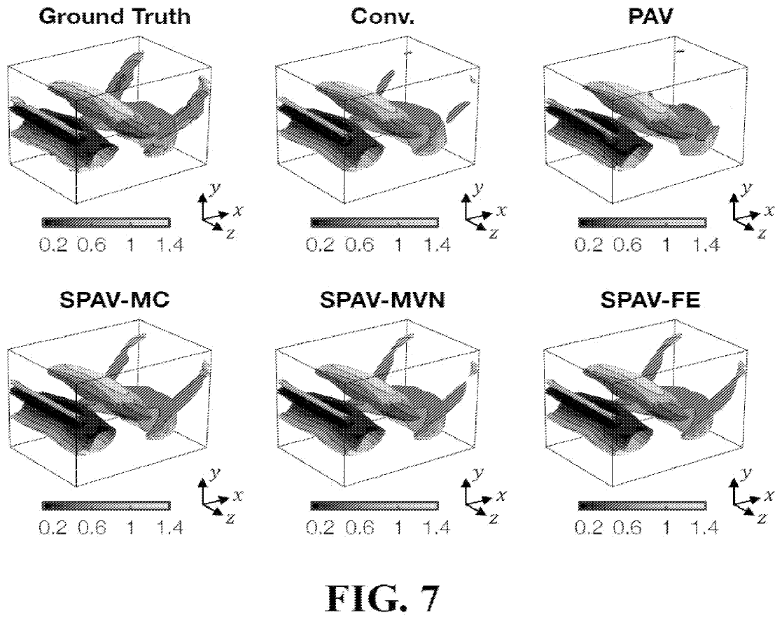

To mimic localization uncertainties that were representative of particle localization based on DIH, particle positions were corrupted with additive Gaussian errors that were centered with equal uncertainty in the x- and y-directions and elongated uncertainty in the z-direction. We used experimentally determined error magnitudes of σₓ=σ_{y}=10⁻³ and σ_{z}=6×10⁻² for the non-dimensional domain. FIG. 7 illustrates a graphical comparison of the flow fields reconstructed from this noisy data using the five above noted approaches and compares that to the ground truth data. As is clear from FIG. 7, the PAV outperformed the conventional approach and the SPAV options all outperformed the conventional approach as well as the PAV approach. For example, qualitative differences between these results are clearly seen in the sinewy vertical arms that branch off the forward-most dominant vortical structure in the graphs provided in FIG. 7. The SPAV approaches faithfully captured these portions of the fluid flow whereas the conventional approach did not. The same trend is also apparent from the quantitative comparisons presented in Table 2, which shows a substantial improvement by the use of the SPAV approaches.

TABLE 2
Velocity and pressure errors from the noisy tests

| Method | eᵤ, % | eᵥ, % | e_{w}, % | eₚ, % |
|---|---|---|---|---|
| conv | 2.0 | 5.2 | 12.5 | 7.4 |
| PAV | 3.4 | 9.2 | 22.8 | 16.7 |
| SPAV-MC | 1.3 | 2.9 | 8.7 | 5.0 |
| SPAV-MVN | 1.4 | 3.0 | 8.1 | 5.0 |
| SPAV-FE | 1.1 | 2.6 | 7.4 | 4.2 |

Among the different SPAV options we evaluated, the fluid element technique appeared to exhibit the best performance. This may be due to its “cheap” implementation, which facilitated much larger batch sizes for the training of the PINN for that option. The larger batch sizes may have improved the speed and stability of the gradient descent-type training. However, the fluid element approximation assessment may break down in flows with strong velocity gradients.

Our PAV approach exhibited lower accuracy even than conventional PINN velocimetery in this particular set of testing in the presence of noise (compared to the slight advantage for the noise-free testing that was found to exist as can be appreciated from the above and FIGS. 4-6). The heightened sensitivity to noise found in the PAV approach for this set of tests could be due to complex data loss term of the PAV approach. However, the PAV particle advection scheme provides an essential improvement over the conventional approach in the context of non-ideal advection effects (e.g. finite particle drag, thermophoresis). This shows that use of embodiments of our PAV and/or SPAV approaches can provide substantial improvement in terms of accurately assessing fluid flow in various environments (e.g. harsh, challenging environments, etc.).

In another test based on the second embodiment of our system and process described above configured for particle transport assessment, we included inertial transport effects into a forward simulation of particle-laden flow. Flow data was obtained from a DNS of forced isotropic turbulence that is available in the Johns Hopkins Turbulence Database. The flow has a Taylor microscale Reynolds number of 433. A subdomain of 1283 voxels was extracted from the original data set and scaled to a physical size of 10 cm³ by assuming a carrier fluid of air. The domain was seeded with 50,000 spherical soda lime glass beads at a fixed density of 2500 kg/m³. Each bead was assigned a random diameter drawn from one of two Gaussian distributions. The first distribution had a mean diameter of 35 μm and standard deviation of 2 μm; the second distribution had a mean of 70 μm and standard deviation of 4 m; half the beads were drawn from the former distribution, the rest were drawn from the latter. Using the fluid's Kolmogorov time scale, the mean particle Stokes number of the small and large particles were 1 and 5, respectively, indicating strong particle lag. The motion of these particles was modelled using the Maxey-Riley equation, simplified via the high particle-to-fluid density ratio and assuming a small particle size compared to the flow length scale. The equation was solved with a second-order Runga-Kutta scheme. To ensure statistical convergence, we conducted our forward simulation in an enlarged domain of 150³ voxels over 201 frames; only about 31,000 tracks in the central 128³-voxel regime during the final 41 frames were used for the following reconstruction.

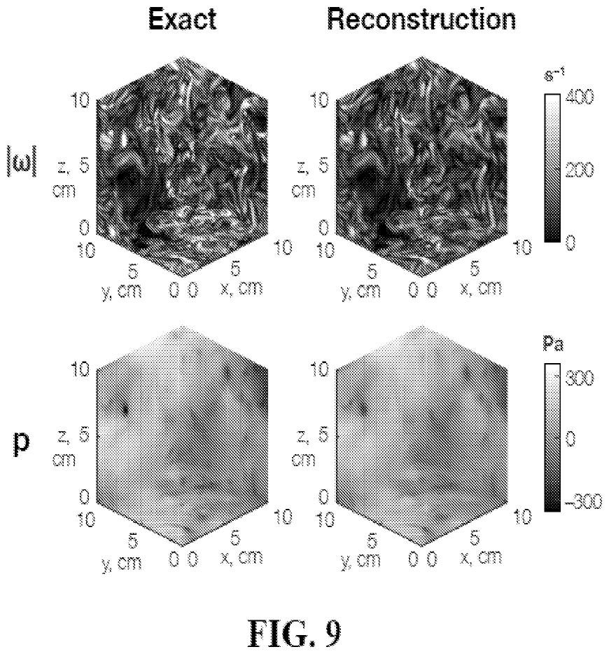

FIG. 9 shows cut plots of vorticity and pressure from the “ground truth” DNS and reconstructions. Cuts are shown at the bottom (z=0 cm), rear (y=10 cm), and right (x=10 cm) face of the domain. For this reconstructions, no boundary condition nor prior information of particle size was utilized. Each particle size was randomly initialized using a draw from a Gaussian distribution of mean 52.5 μm and standard deviation 4 μm. As can be appreciated from FIG. 9, our algorithm successfully recovers the vortical structures of the underlying forced isotropic homogeneous flow and the pressure field is correctly inferred, all despite the non-ideal advection effects including slip and gravitational settling. Quantitatively, the relative errors of the vorticity and pressure reconstruction are 25% and 17.8%, respectively. Such reconstructions are not possible using alternative systems and methods of assessment.

Our conducted testing showed that our PAV and SPAV approaches were effective and provided significant improvement in evaluation of fluid flows compared to existing techniques. It is also contemplated that these approaches can be further improved upon by developing localization and measurement PDFs for use in implementation of SPAV for various modalities. Additionally, the maximum likelihood approach can be adjusted to a full Bayesian technique to conduct simultaneous localization and tracking, which may include use of a model of key uncertainties like ghost particles and broken tracks. Yet another option for adjustment is implementation of a finite particle advection model to account for physical processes like Stokes drag, as demonstrated in the second example, and thermophoresis.

It should also be appreciated that different embodiments of the method, system, and apparatus can be developed to meet different sets of design criteria. For example, the particular type of network connection, server configuration or client configuration for a device for use in embodiments of the method can be adapted to account for different sets of design criteria. As another example, the type of camera 9, light source 7, and/or sensors 10 used in the system can be adapted to meet a particular set of design criteria. Some embodiments may not use any sensors 10 while others may use one or more sensors, for example. As yet another example, the type of structure or unconfined region of interest 5 (e.g. vessel or conduit) in which the fluid is passed through can be any number of different types of structures to accommodate a particular set of design objectives. As yet another example, embodiments may use a particulate feeding device 13 that provides a feed of particulates 15 or may not include such a device. As yet another example, the use of a flow driving mechanism 21 and (if used) the type of this mechanism (e.g. pump, fan, compressor, etc.) can be adapted for different embodiments of the system 1.

As yet another example, the configuration and position of the at least one computer device 3 can be in any of a number of suitable configurations. In some embodiments, the computer device 3 can be a device that hosts a fluid flow assessment service and can provide results to a user device based on camera image data and/or other sensor data it receives directly from the camera 9 and/or sensors 10 or via a user computer device that may have that data. The computer device 3 can communicate with a user device for generation of output of the results of the fluid flow assessment performed by the computer device 3. In other arrangements, the computer device 3 can be part of a local area network or other arrangement and directly perform the fluid flow assessment based on image data and/or sensor data it receives from the camera 9 and/or sensor(s) 10.

As yet another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of a process, an apparatus, device, system, and methods of making and using the same have been shown and described above, it is to be distinctly understood that the invention is not limited thereto but may be otherwise variously embodied and practiced within the scope of the following claims.

What is claimed is:

1. A system for fluid flow assessment comprising:
a computer device having a processor connected to a non-transitory computer readable medium configured to receive image data from at least one camera device positioned to capture images of a flow of fluid passing through a region of interest, the computer device configured to perform a fluid flow assessment process by running code stored in the non-transitory computer readable medium defining the fluid flow assessment process such that the computer device is configured to utilize at least one of:
$${ℒ}_{data}^{PAV} = \frac{1}{{n}_{p}} {\sum }_{i = 1}^{{n}_{p}} {‖ {\hat{x}}_{2}^{i} - {x}_{2} ( {\hat{x}}_{1}^{i} , θ ) ‖}_{2}^{2} and \qquad ( 1 )$$
$${L}_{data}^{SPAV} = - {\sum }_{i = 1}^{{n}_{p}} log [ P ( {\hat{x}}_{2}^{i} \vert {\hat{x}}_{1}^{i} , θ ) ] , \qquad ( 2 )$$
wherein, utilization of Eq. (2) includes numerical approximations of at least one of:
d) SPAV-MC:
$$P ( {\hat{x}}_{2} \vert {\hat{x}}_{1} , θ ) \approx \frac{1}{{n}_{s}} {\sum }_{j = 1}^{{n}_{s}} P ( {\hat{x}}_{2} \vert {x}_{1}^{j} , θ ) , \qquad ( 3 )$$
e) SPAV-MVN:
$$P ( {\hat{x}}_{2} \vert {\hat{x}}_{1} , θ ) = {det [ 2 π ( Γ + {\hat{Γ}}_{2} ) ]}^{- 1 / 2} exp [ - \frac{1}{2} {( {\hat{x}}_{2} - {\hat{μ}}_{2} )}^{\text{?}} {( Γ + {\hat{Γ}}_{2} )}^{- 1} ( {\hat{x}}_{2} - {\hat{μ}}_{2} ) ] , and \qquad ( 4 )$$
$$\text{?} \text{indicates text missing or illegible when filed}$$
f) SPAV-FE (based on SPAV-MVN):
$${\hat{μ}}_{2} = \frac{1}{6} ( {x}_{2}^{+ 1} + {x}_{2}^{- 1} + {x}_{2}^{+ 2} + {x}_{2}^{- 2} + {x}_{2}^{+ 3} + {x}_{2}^{- 3} ) , \qquad ( 5 )$$
$$U \sum {V}^{\text{?}} = [ {x}_{2}^{+ 1} , {x}_{2}^{- 1} , {x}_{2}^{+ 2} , {x}_{2}^{- 2} , {x}_{2}^{+ 3} , {x}_{2}^{- 3} ] - {\hat{μ}}_{2} {1}^{\text{?}} , and \qquad ( 6 )$$
$${\hat{Γ}}_{2} = \frac{1}{2} {U}^{\text{?}} {\sum }^{o 2} U \qquad ( 7 )$$
$$\text{?} \text{indicates text missing or illegible when filed}$$
wherein for Eqs. (1) and (2), [symbol] _{data} is a measurement component of an objective loss designed for velocity and pressure reconstruction and the superscripts “PAV” and “SPAV” indicate particle advection velocimetry (PAV) and stochastic particle advection velocimetry (SPAV) and P is a probability density function (PDF);
the summations cover a total of nₚ localized particle pairs; the vector \hat{x}ⁱ=[x, y, z]^{T} denotes the position of the ith individual particle, where the symbol \hat{ } indicates an estimated quantity, and the subscripts 1 and 2 denote the position before and after advection, respectively; the vector θ contains the current estimate of the velocity and pressure fields;
for Eqs. (3) to (7), nₛ denotes the number of Monte Carlo samples, \hat{x}ⁱ, drawn from the localization PDF before advection, the matrix Γ is a covariance matrix that characterizes a generic particle measurement uncertainty, symbols \hat{μ}₂ and \hat{Γ}₂ denote an estimated mean position and covariance matrix of the particle advected from the position \tilde{x}ᵢ, symbol x₂^{±j} denotes advected points in the fluid element (FE) approximation that are placed along the jth principal axis of a 3D localization file; the sign of the superscript represents either a positive or negative direction along a principal axis, U and V are singular matrices that are obtained by applying a singular value decomposition to a right hand side of Eq. (6), and Σ is a diagonal matrix that contains the corresponding singular values and is obtained in the same decomposition; 1 is a 6×1 vector of ones; and ^{o2} is a Hadamard exponent.

2. The system of claim 1, wherein the fluid flow assessment process is a particle advection velocimetry (PAV) process or a stochastic particle advection velocimetry (SPAV) process.

3. The system of claim 1, comprising:
a structure, the structure including a vessel or a conduit that contains the fluid flow to be measured.

4. The system of claim 1, comprising:
at least one sensor communicatively connected to the computer device, the at least one sensor positioned to provide measurement data about the flow of fluid.

5. The system of claim 1, comprising:
the camera and a light source positioned to illuminate a pre-selected region of the region of interest for image capturing by the camera.

6. The system of claim 5, wherein the light source includes a laser or at least one light emitting device.

7. The system of claim 1, also comprising:
a fluid flow drive mechanism connected to a structure through which the flow of fluid passes through the region of interest.

8. The system of claim 1, comprising:
a particulate feeding device positioned to provide a feed of particulates from a source of particulates for providing the particulates to the flow of fluid at a position that is upstream of a position of the camera.

9. The system of claim 1, wherein the fluid includes a gas and/or a liquid.

10. The system of claim 9, wherein the flow of fluid included particles, the particles being droplets of a liquid, solid particulates, or cellular material.

11. The system of claim 1, wherein the fluid flow assessment process is configured to assess particle transport.

12. The system of claim 1, wherein the fluid flow assessment process is configured to assess fluid flow and particle transport that occurs via the fluid flow.

13. A method for fluid flow assessment comprising:
capturing images of a flow of fluid, the flow of fluid having particles therein;
analyzing image data of the captured images to perform a fluid flow assessment, the fluid flow assessment including performance of one or more of:
$${ℒ}_{data}^{PAV} = \frac{1}{{n}_{p}} {\sum }_{i = 1}^{{n}_{p}} {‖ {\hat{x}}_{2}^{i} - {x}_{2} ( {\hat{x}}_{1}^{i} , θ ) ‖}_{2}^{2} and \qquad ( 1 )$$
$${L}_{data}^{SPAV} = - {\sum }_{i = 1}^{{n}_{p}} log [ P ( {\hat{x}}_{2}^{i} \vert {\hat{x}}_{1}^{i} , θ ) ] , \qquad ( 2 )$$
wherein utilization of Eq. (2) includes at least one numerical approximation of:
d) SPAV-MC:
$$P ( {\hat{x}}_{2} \vert {\hat{x}}_{1} , θ ) \approx \frac{1}{{n}_{s}} {\sum }_{j - 1}^{n} P ( {\hat{x}}_{2} \vert {\tilde{x}}_{1}^{j} , θ ) , \qquad ( 3 )$$
e) SPAV-MVN:
$$P ( {\hat{x}}_{2} \vert {\hat{x}}_{1} , θ ) = {det [ 2 π ( Γ + {\hat{Γ}}_{2} ) ]}^{- 1 / 2} exp [ - \frac{1}{2} {( {\hat{x}}_{2} - {\hat{μ}}_{2} )}^{\text{?}} {( Γ + {\hat{Γ}}_{2} )}^{- 1} ( {\hat{x}}_{2} - {\hat{μ}}_{2} ) ] , \qquad ( 4 )$$
$$\text{?} \text{indicates text missing or illegible when filed}$$
f) SPAV-FE (based on SPAV-MVN):
$${\hat{μ}}_{2} = \frac{1}{6} ( {x}_{2}^{+ 1} + {x}_{2}^{- 1} + {x}_{2}^{+ 2} + {x}_{2}^{- 2} + {x}_{2}^{+ 3} + {x}_{2}^{- 3} ) , \qquad ( 5 )$$
$$U \sum {V}^{\text{?}} = [ {x}_{2}^{+ 1} , {x}_{2}^{- 1} , {x}_{2}^{+ 2} , {x}_{2}^{- 2} , {x}_{2}^{+ 3} , {x}_{2}^{- 3} ] - {\hat{μ}}_{2} {1}^{\text{?}} , and \qquad ( 6 )$$
$${\hat{Γ}}_{2} = \frac{1}{2} {U}^{\text{?}} {\sum }^{o 2} U \qquad ( 7 )$$
$$\text{?} \text{indicates text missing or illegible when filed}$$
wherein in Eqs. (1) and (2), [symbol] _{data} is the measurement component of an objective loss designed for velocity and pressure reconstruction and the superscripts “PAV” and “SPAV” indicate particle advection velocimetry (PAV) and stochastic particle advection velocimetry (SPAV), respectively; P is a probability density function (PDF), and the summations cover a total of nₚ localized particle pairs; the vector \hat{x}ⁱ=[x, y, z]^{T} denotes the position of the ith individual particle, where the symbol \hat{ } indicates an estimated quantity, and the subscripts 1 and 2 denote the position before and after advection, respectively; the vector θ contains the current estimate of the velocity and pressure fields;
wherein for Eqs. (3) to (7), nₛ denotes the number of Monte Carlo samples, \tilde{x}ⁱ, drawn from the localization PDF before advection, matrix Γ is a covariance matrix that characterizes the generic particle measurement uncertainty, symbols \hat{μ}₂ and \hat{Γ}₂ denote an estimated mean position and covariance matrix of the particle advected from the position \tilde{x}₁, symbol x₂^{±j} denotes the advected points in the fluid element (FE) approximation that are placed along the jth principal axis of the 3D localization file; the sign of the superscript represents either a positive or negative direction along a principal axis, U and V are two singular matrices that are obtained by applying a singular value decomposition to the right hand side of Eq. (6), and Σ is a diagonal matrix that contains the corresponding singular values and is obtained in the same decomposition, and 1 is a 6×1 vector of ones and ^{o2} is a Hadamard exponent.

14. The method of claim 13, wherein the fluid includes a gas and/or a liquid.

15. The method of claim 14, wherein the particles are droplets of a liquid, solid particulates, or cellular material.

16. The method of claim 13, wherein the fluid flow assessment process is a particle advection velocimetry (PAV) process or a stochastic particle advection velocimetry process (SPAV).

17. The method of claim 13, wherein the 3D localization file is a Portable Document Format file, a text format file (.txt), a comma-separated values (.csv) file, or a data (.dat) file.

18. The method of claim 13, wherein the fluid flow assessment assesses particle transport.

19. The method of claim 13, wherein the fluid flow assessment assess fluid flow and particle transport that occurs via the fluid flow.

20. A system for fluid flow assessment comprising:
a computer device having a processor connected to a non-transitory computer readable medium configured to receive image data from at least one camera device positioned to capture images of a flow of fluid passing through a region of interest, the computer device configured to perform a fluid flow assessment process by running code stored in the non-transitory computer readable medium defining the fluid flow assessment process such that the computer device is configured to utilize at least one of:
$${ℒ}_{data}^{PAV} ( {Θ}_{x} ) = \frac{1}{{n}_{p}} {\sum }_{k = 1}^{{n}_{p}} \frac{1}{{n}_{k} - 1} {\sum }_{j = 1}^{{n}_{k} - 1} {‖ {θ}_{x , j}^{k} - {x}_{j}^{k} ‖}_{2}^{2} and \qquad ( 1 )$$
$${ℒ}_{data}^{SPAV} ( {Θ}_{x} ) = - {\sum }_{k = 1}^{{n}_{p}} {\sum }_{j = 1}^{{n}_{k} - 1} P ( {x}_{j}^{k} \vert {θ}_{x , j}^{k} ) , \qquad ( 2 )$$
wherein for Eqs. (1) and (2), [symbol] _{data} is a measurement component of an objective loss designed for velocity and pressure reconstruction and the superscripts “PAV” and “SPAV” indicate particle advection velocimetry (PAV) and stochastic particle advection velocimetry (SPAV);
the summations cover a total of nₚ localized particle pairs; the subscripts 1 and 2 denote positions before and after advection, respectively; vector θ contains a current estimate of the velocity and pressure fields;
$${θ}_{x , j}^{k}$$
is an advected location of a kth particle at a jth step, nₖ is a number of positions recorded along a track,
$${x}_{j}^{k}$$
is a particle position for a kth particle at a jth step, P is a probability density function, and Θₓ is a tensor.

21. The system of claim 20, comprising:
a structure, the structure including a vessel or a conduit that contains the fluid flow to be measured.

22. The system of claim 20, comprising:
at least one sensor communicatively connected to the computer device, the at least one sensor positioned to provide measurement data about the flow of fluid.

23. The system of claim 20, comprising:
the camera and a light source positioned to illuminate a pre-selected region of the region of interest for image capturing by the camera.

24. The system of claim 23, wherein the light source includes a laser or at least one light emitting device.

25. The system of claim 20, also comprising:
a fluid flow drive mechanism connected to a structure through which the flow of fluid passes through the region of interest.

26. The system of claim 20, comprising:
a particulate feeding device positioned to provide a feed of particulates from a source of particulates for providing the particulates to the flow of fluid at a position that is upstream of a position of the camera.

27. The system of claim 20, wherein the fluid includes a gas and/or a liquid.

28. The system of claim 27, wherein the flow of fluid included particles, the particles being droplets of a liquid, solid particulates, or cellular material.

29. A method for fluid flow assessment comprising:
capturing images of a flow of fluid, the flow of fluid having particles therein;
analyzing image data of the captured images to perform a fluid flow assessment, the fluid flow assessment including performance of one or more of:
$${ℒ}_{data}^{PAV} ( {Θ}_{x} ) = \frac{1}{{n}_{p}} {\sum }_{k = 1}^{{n}_{p}} \frac{1}{{n}_{k} - 1} {\sum }_{j = 1}^{{n}_{k} - 1} {‖ {θ}_{x , j}^{k} - {x}_{j}^{k} ‖}_{2}^{2} and \qquad ( 1 )$$
$${ℒ}_{data}^{SPAV} ( {Θ}_{x} ) = - {\sum }_{k = 1}^{{n}_{p}} {\sum }_{j = 1}^{{n}_{k} - 1} P ( {x}_{j}^{k} \vert {θ}_{x , j}^{k} ) , \qquad ( 2 )$$
wherein for Eqs. (1) and (2), [symbol] _{data} is a measurement component of an objective loss designed for velocity and pressure reconstruction and the superscripts “PAV” and “SPAV” indicate particle advection velocimetry (PAV) and stochastic particle advection velocimetry (SPAV); and
the summations cover a total of nₚ localized particle pairs; the subscripts 1 and 2 denote positions before and after advection, respectively; vector θ contains a current estimate of the velocity and pressure fields;
$${θ}_{x , j}^{k}$$
is an advected location of a kth particle at a jth step, nₖ is a number of positions recorded along a track,
$${x}_{j}^{k}$$
is a particle position for a kth particle at a jth step, P is a probability density function, and Θₓ is a tensor.

30. The method of claim 29, wherein the fluid includes a gas and/or a liquid.

31. The method of claim 30, wherein the particles are droplets of a liquid, solid particulates, or cellular material.
